(19) United States
(12) Patent Application Publication
(10) Pub. No.: US 2026/0003896 A1
(43) Pub. Date: Jan. 1, 2026

(54) ELECTRONIC DEVICE SUPPORTING SEARCH FUNCTION AND METHOD FOR OPERATING THE SAME

(71) Applicant: SAMSUNG ELECTRONICS CO., LTD., Suwon-si (KR)

(72) Inventors: Wanje PARK, Suwon-si (KR); Doosuk KANG, Suwon-si (KR); Bosung KIM, Suwon-si (KR); Chaeyeon SON, Suwon-si (KR); Jaeyung YEO, Suwon-si (KR); Gwangho CHOI, Suwon-si (KR)

(73) Assignee: SAMSUNG ELECTRONICS CO., LTD., Suwon-si (KR)

(21) Appl. No.: 19/237,672

(22) Filed: Jun. 13, 2025

Related U.S. Application Data
(63) Continuation of application No. PCT/KR2025/007567, filed on Jun. 2, 2025.

(30) Foreign Application Priority Data
Jun. 29, 2024 (KR) 10-2024-0085876
Aug. 27, 2024 (KR) 10-2024-0115030

(51) Int. Cl. G06F 16/332

(52) U.S. Cl. CPC G06F 16/3322

(57) ABSTRACT

An electronic device includes: a display; a memory including one or more storage media storing instructions; and at least one processor including a processing circuit, wherein the instructions, when executed by the at least one processor individually or collectively, cause the electronic device to: obtain a user query; access at least one application associated with the user query to obtain personal use data; obtain at least one search word associated with the user query from the obtained personal use data; generate at least one command by tuning the user query based on the obtained at least one search word; and display, via the display, a user interface screen in which the user query, the generated at least one command, and the obtained at least one search word are arranged according a first layout.

### CROSS-REFERENCE TO RELATED APPLICATIONS

This application is a continuation of International Application No. PCT/KR2025/007567 designating the United States, filed on Jun. 2, 2025, in the Korean Intellectual Property Receiving Office, which claims priority from Korean Patent Application No. 10-2024-0085878, filed on Jun. 29, 2024, and Korean Patent Application No. 10-2024-0115030, filed on Aug. 27, 2024, in the Korean Intellectual Property Office, the disclosures of each of which are incorporated by reference herein in their entireties.

### BACKGROUND

### Field

The disclosure relates to an electronic device that generates a search result based on artificial intelligence and a method for operating the same.

### Description of Related Art

An artificial neural network is a computational architecture that models the biological brain. Based on artificial neural networks, technologies, such as deep learning or machine learning, may be implemented. As an example of an artificial neural network, a deep neural network or deep learning may have a multi-layer structure that includes a plurality of layers.

Artificial Intelligence (AI) models are being used in various ways to analyze vision (e.g., sight, image, or picture) and voice (e.g., sound). Research and development on hardware technologies related to AI models are actively being conducted to effectively operate AI models on mobile terminals. For example, research is also being conducted on enhancing the hardware structure considering AI models for the purpose of optimizing the MAC operation (multiply-accumulation) performed in deep learning AI models.

The above-described information is provided as related art for the purpose of helping understanding of the disclosure. The foregoing cannot be claimed as, or used to determine, the prior art related to the disclosure.

### SUMMARY

According to an aspect of the disclosure, an electronic device includes: a display; a memory including one or more storage media storing instructions; and at least one processor including a processing circuit, wherein the instructions, when executed by the at least one processor individually or collectively, cause the electronic device to: obtain a user query; access at least one application associated with the user query to obtain personal use data; obtain at least one search word associated with the user query from the obtained personal use data; generate at least one command by tuning the user query based on the obtained at least one search word; and display, via the display, a user interface screen in which the user query, the generated at least one command, and the obtained at least one search word are arranged according a layout.

According to an aspect of the disclosure, a non-transitory computer-readable recording medium stores at least one computer-readable instruction, wherein the at least one computer-readable instruction, when executed by at least one processor of an electronic device, causes the electronic device to perform operations including: obtaining a user query; accessing at least one application associated with the user query to obtain personal use data; obtaining at least one search word associated with the user query from the obtained personal use data; generating at least one command by tuning the user query based on the obtained at least one search word; and displaying a user interface screen in which the user query, the generated at least one command, and the obtained at least one search word are arranged according a layout.

According to an aspect of the disclosure, a method for operating an electronic device, includes: obtaining a user query; accessing at least one application associated with the user query to obtain personal use data; obtaining at least one search word associated with the user query from the obtained personal use data; generating at least one command by tuning the user query based on the obtained at least one search word; and displaying a user interface screen in which the user query, the generated at least one command, and the obtained at least one search word are arranged according a layout.

### BRIEF DESCRIPTION OF THE DRAWINGS

The above and other aspects, features, and advantages of embodiments of the disclosure will be more apparent from the following description taken in conjunction with the accompanying drawings, in which:

FIG. 1 is a view illustrating an example configuration of an electronic device in a network environment according to one or more embodiment(s);

FIG. 2 is a block diagram illustrating an example configuration of an electronic device capable of performing operations according to one or more embodiment(s);

FIG. 3 is an example block diagram illustrating providing a generative artificial intelligence (AI) function in an electronic device according to one or more(s);

FIG. 4 is a block diagram illustrating an example configuration of an AI system capable of performing operations according to one or more embodiment(s);

FIG. 5 is a block diagram illustrating an example configuration of a prompt generation/processing system in an electronic device according to one or more embodiment(s);

FIG. 6A is a control flowchart for generating an example prompt corresponding to a user query in an electronic device according to one or more embodiment(s);

FIG. 6B is a control flowchart for performing an example response of an AI model corresponding to a user query in an electronic device according to one or more embodiment(s);

FIGS. 7A to 7E are views illustrating an example user interface for generating a prompt in an electronic device according to one or more embodiment(s);

FIGS. 8A and 8B are views illustrating example user interface(s) for generating a prompt in an electronic device according to one or more embodiment(s);

FIGS. 9A and 9B are views illustrating example user interface(s) for generating a prompt in an electronic device according to one or more embodiment(s);

FIGS. 10A and 10B are views illustrating example user interface(s) displaying a search word for editing a prompt in an electronic device according to one or more embodiment(s);

FIGS. 11A and FIG. 11B are views illustrating sequentially accessing example application(s) to generate a prompt in an electronic device according to one or more embodiment(s);

FIG. 11C is a view illustrating generating an example prompt by a sequential application in an electronic device according to one or more embodiment(s);

FIG. 11D is a view illustrating sequentially processing an example user query or a prompt using a plurality of large language models (LLMs) in an electronic device according to one or more embodiment(s);

FIGS. 12A to 12C are views illustrating example prompt editing screen(s) using an expandable display in an electronic device according to one or more embodiment(s);

FIG. 13 is an view illustrating an example prompt editing screen in an electronic device according to one or more embodiment(s); and

FIG. 14 is an view illustrating an example user interface for processing utilization of a customized search result in an electronic device according to one or more embodiment(s).

### DETAILED DESCRIPTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

Various embodiments of the disclosure may provide an electronic device capable of outputting a search result based on a prompt (or command) reflecting a user's intention based on AI and a method for operating the electronic device.

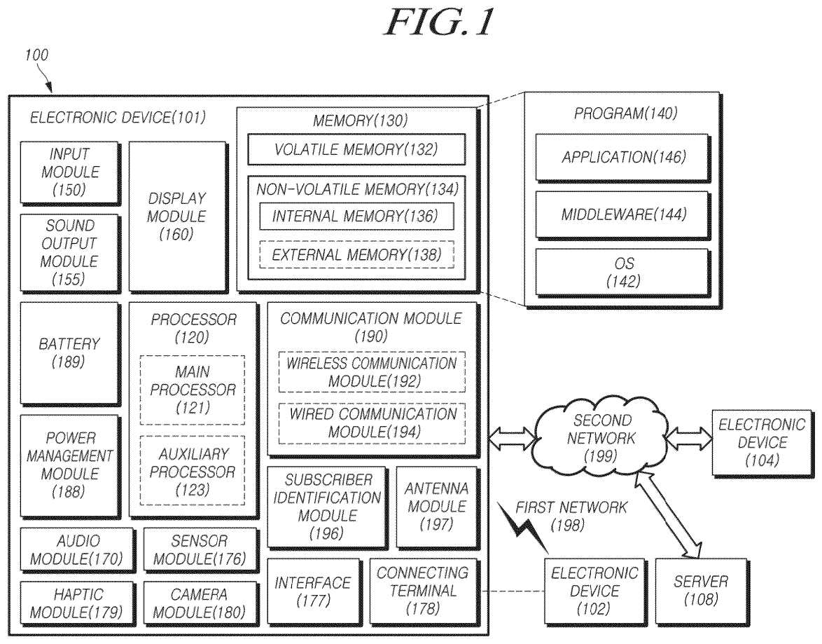

FIG. 1 is a block diagram illustrating an example configuration of an electronic device 101 in a network environment 100 according to one or more embodiment(s).

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120 and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134 (including internal memory 136 and external memory 138). According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an ISP or a CP) may be implemented as part of another component (e.g., the camera module 180 or the communication module 190) functionally related to the auxiliary processor 123. According to an embodiment, the auxiliary processor 123 (e.g., the NPU) may include a hardware structure specified for artificial intelligence model processing. The AI model may be generated via machine learning. Such learning may be performed, e.g., by the electronic device 101 where the AI is performed or via a separate server (e.g., the server 108). Learning algorithms may include, but are not limited to, e.g., supervised learning, unsupervised learning, semi-supervised learning, or reinforcement learning. The AI model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The AI model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, ISPs, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IOT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

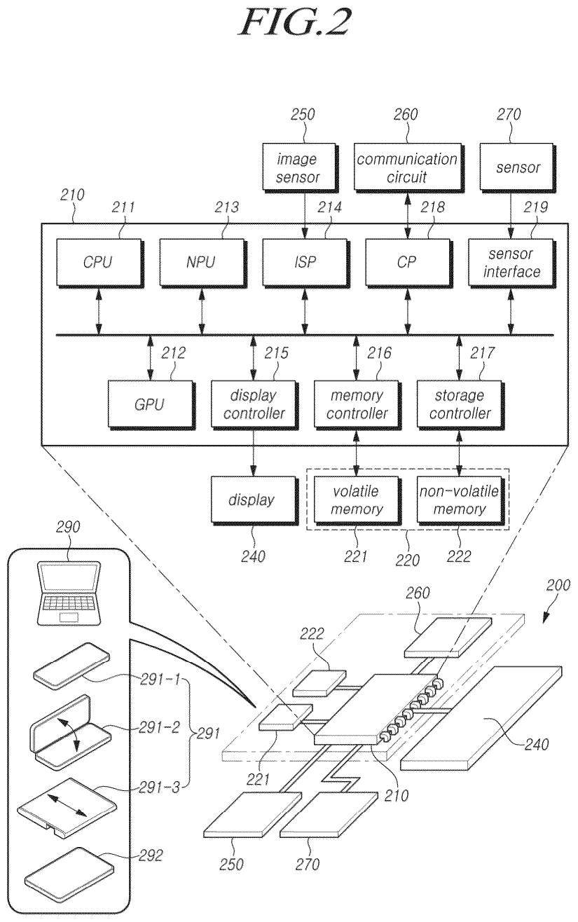

FIG. 2 illustrates a block diagram of an example configuration of an electronic device 200 capable of performing the operations described herein.

Referring to FIG. 2, the electronic device 200 may be one of various types of electronic devices, such as a notebook computer 290, smartphones 291 having various form factors (e.g., a bar-type smartphone 291-1, a foldable smartphone 291-2, or a slidable (or rollable) smartphone 291-3), a tablet PC 292, a cellular telephone (not shown), and any other similar computing devices (not shown). The components illustrated in FIG. 2, the relationships thereof, and the functions thereof are merely for illustration, and are not intended to limit the implementations described or claimed in the disclosure thereto. The electronic device 200 may be referred to as a mobile device, a user equipment, a multifunctional device, a portable device, or a server.

The electronic device 200 may comprise various components including at least one processor 210 (hereinafter, the processor 210), at least one memory 220 (hereinafter, the memory 220), at least one display 240 (hereinafter, the display 240), at least one image sensor 250 (hereinafter, the image sensor 250), at least one communication circuitry 260 (hereinafter, the communication circuitry 260), and/or at least one sensor 270 (hereinafter, the sensor 270). The aforementioned components are merely of an example. For example, the electronic device 200 may comprise other components (e.g., a power management integrated circuitry (PMIC), an audio processing circuitry, an antenna, a rechargeable battery, or an input/output interface). For example, some components may be omitted from the electronic device (200). For example, some components may be integrated into one component.

The processor 210 may be implemented as one or more integrated circuit (or circuitry) (IC) chips and may perform various data processing. The processor 210 may include at least one electrical circuitry and may process instructions (or program, data, and so on) stored in the memory 220 individually or collectively in a distributed manner. The processor 210 may include a processor assembly that includes one or more processing circuitries. The processor may include any processing circuitry that may be operative for controlling operations and performance of one or more components (e.g., the memory 220, a display 240, the image sensor 250, the communication circuitry 260, and/or the sensor 270) of the electronic device. For example, the processor 210 (e.g., an application processor (AP)) may be implemented as a system on chip (SoC) (e.g., one chip or chipset). For example, the processor 210 may be implemented as a plurality of cores (or at least one core circuitry), a plurality of chips, or a plurality of chipsets. For example, the processor 210 may comprise one or more processing circuitry. For example, the processor 210 may comprise one or more processing circuitry which are individually and/or collectively configured to perform various functions of the disclosure. As a non-limiting example, at least a portion of the processor 210 may be included in a first chip of the electronic device 200 and at least another portion of the processor 210 may be included in a second chip of the electronic device 200 different from the first chip of the electronic device 200.

For example, the processor 210 may comprise a central processing unit (CPU) 211, a GPU 212, a NPU 213, an image signal processor (ISP) 214, a display controller 215, a memory controller 216, a storage controller 217, a communication processor (CP) 218, and/or a sensor interface 219. These components of the processor 210 are merely of an example. For example, the processor 210 may further comprise other components. For example, some components of the processor 210 may be omitted from the processor 210. For example, some components of the processor 210 may be included as separate components of the electronic device 200 outside the processor 210. For example, some components of the processor 210 (e.g., the memory controller 216) may be included in other components of the electronic device 200 (e.g., at least a portion of the memory 220, an interface (e.g., usable for connecting to at least one component of the electronic device 200), the display 240, and/or the image sensor 250).

The processor 210 may cause other components of the electronic device 200 to perform various operations by executing instructions stored in the memory 220. The CPU 211 (or a central processing circuitry) may be configured to control the components of the processor 210 based on execution of instructions stored in the memory 220 (e.g., the volatile memory 221 and/or the non-volatile memory 222). The GPU 212 (or a graphic processing circuitry) may be configured to execute parallel computations (e.g., rendering). The NPU 213 (or a neural processing circuitry, or an AI chip) may be configured to execute operations (e.g., convolution computations) for an AI model. The ISP 214 (or an ISP circuitry) may be configured to process a raw image obtained from the image sensor 250 in a format suitable for a component in the electronic device 200 or a component of the processor 210. The display controller 215 (or a display control circuitry, or a display processing unit (DPU)) may be configured to process an image obtained from the CPU 211, the GPU 212, the ISP 214, or the memory 220 (e.g., the volatile memory 221) in a format suitable for the display 240. The memory controller 216 (or a memory control circuitry) may be configured to control reading data from the volatile memory 221 and writing data to the volatile memory 221. The storage controller 217 (or a storage control circuitry) may be configured to control reading data from the non-volatile memory 222 and writing data to the non-volatile memory 222. The CP 218 (or a communication processing circuitry) may be configured to process data obtained from a component of the processor 210 in a format suitable for transmission to another electronic device via the communication circuitry 260, or to process data obtained from another electronic device via the communication circuitry 260 in a format suitable for processing of the component of the processor 210. For example, the communication circuitry 260 may comprise one or more communication circuitry. The sensor interface 219 (or a sensing data processing circuitry, a sensor hub) may be configured to process data on a state of the electronic device 200 and/or a state around the electronic device 200, obtained through the sensor 270, in a format suitable for a component of the processor 210.

The memory 220 may comprise one or more storage mediums (or one or more storage devices). For example, the memory 220 may include a memory assembly that includes one or more storage mediums. For example, the one or more storage mediums may comprise a permanent memory (e.g., the non-volatile memory 222) such as a hard drive, a flash memory, a read-only memory (ROM), a semi-permanent memory (e.g., the volatile memory 221) such as a random access memory (RAM), a storage (or a storage assembly) of any other suitable type, or any combination thereof. The memory 220 may comprise a cache memory which is a memory of one or more different types used to store data for performing a function or feature of the electronic device 200 at least temporarily. As a non-limiting example, the cache memory may be included in the processor 210. The memory 220 may be fixedly embedded within the electronic device 200, or may be incorporated onto one or more suitable types of components that may be repeatedly inserted into the electronic device 200, and removed from the electronic device 200 (e.g., a subscriber identity module (SIM) card, and/or a secure digital (SD) card).

For example, the memory 220 may store one or more software applications such as an operating system (or a system) software application, a firmware software application, a driver software application, a plug-in (e.g., add-in, add-on, and/or applet) software application, and/or any other suitable software application. For example, the one or more software applications may include instructions executable by the processor 210. For example, the memory 220 may store instructions callable by an application programming interface (API). For example, the memory 220 may store instructions in a library.

According to an example, the electronic device 200 may execute an instance of at least one AI model. The instance may be, e.g., an object corresponding to a program (or application) such as an AI model. The instance may be referred to as a replica, a pod, a container, or a virtual machine but is not limited thereto. The number of instances may correspond to the size of a resource (e.g., GPU 212 or NPU 213), and accordingly, the number of instances may be used interchangeably with the size of the resource, or the instance may be used interchangeably with the resource.

As an example, a plurality of user requests may be input to the electronic device 200. The user requests may be associated with a service. The user request may be processed by a first instance of the first AI model, and a first processing result may be provided from the first instance of the first AI model. The first processing result may be processed by the first instance of the second AI model, and accordingly, a second processing result may be provided by the first instance of the second AI model. By the sequential processing of the processing results, the first instance of the Mth AI model may receive and process an N-1th processing result. The first instance of the Mth AI model may provide the Nth processing result as a response. Accordingly, a response corresponding to the user request may be provided.

Based on the above-described process, responses respectively corresponding to a plurality of user requests may be provided. On the other hand, since processing should be performed by an instance, it may take a relatively long time to provide responses (hereinafter referred to as a “response time”) respectively corresponding to the plurality of user requests. The response time may affect latency in the corresponding instance. In order to reduce the response time, the electronic device 200 may increase the number of instances of at least one AI model, which may be referred to as scaling out. However, there may be limitations in increasing the number of instances due to hardware and/or software constraints of the electronic device 200 and/or parameters of the AI model (e.g., large language model, LLM).

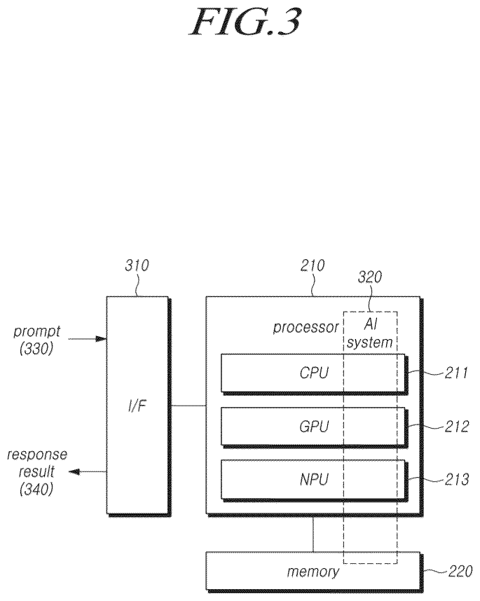

FIG. 3 is an example block diagram illustrating providing a generative artificial intelligence (AI) in an electronic device (e.g., the electronic device 101 of FIG. 1 or the electronic device 200 of FIG. 2 (hereinafter, referred to as an ‘electronic device 200’)) according to one or more embodiment(s).

Referring to FIG. 3, an electronic device 200 may include a processor 210 (e.g., the processor 210 of FIG. 2), a memory 220 (e.g., the memory 220 of FIG. 2), and/or an interface (IF) 220. The electronic device 200 may be a device for providing a service associated with at least one AI system 320 (hereinafter, referred to as an ‘AI system 320’).

The AI system 320 may include at least one AI model (hereinafter, referred to as an ‘AI model’). According to an example, the AI system 320 may analyze received messages and generate a summary message. For example, the summary message may include one or more contents (hereinafter referred to as ‘content’) reprocessed from the received messages to allow the user to easily recognize the content of the received messages. The content may be, e.g., at least one of text, an image, audio, or video.

The AI system 320 may be based on natural language processing (NLP). The NLP is, e.g., a technology which the electronic device 200 understands or processes a natural language input (hereinafter referred to as a “prompt 330” or “command 330”) that may be expressed as a voice and/or text. The electronic device 200 may understand natural language through NLP, grasp human intentions based thereupon, or transmit information in a language that may be understood by humans. In order to understand human language, the NLP may predict the probability of the next word or token of a given text by learning the order of words or tokens. The token is a basic unit for processing or understanding the prompt 330 in the AI model. The main techniques of the NLP include tokenization, part-of-speech tagging, syntax analysis, entity name recognition, or emotional analysis of the prompt 330 corresponding to the user's input.

The I/F 310 may receive a prompt 330 and transmit the received prompt 330 to the processor 210. The prompt 330 may be a medium that serves to guide an operation to be performed by the AI system 320 or a result to be generated in a desired direction. The prompt 330 may be the only window through which the user may communicate with the AI system 320. The prompt 330 needs to be clear and specific in order to obtain an answer close to the desired result from the AI system 320. According to an example, the I/F 310 may receive the response result 340 (e.g., a summary message and/or a response message) processed by the AI system 320 based on the prompt 330 (e.g., received messages) and output a response result 340 obtained by converting the same into a human-recognizable form (e.g., text, image, audio, or video). The I/F 310 may receive or output a natural language in the form of, e.g., voice and/or text with at least one component such as a keyboard, touch panel, display, and/or speaker.

The processor 210 may execute software (e.g., a program) to control at least one other component (e.g., a hardware or software component) of the electronic device 200 electrically connected thereto. The processor 210 may perform various data processing or operations. As at least a part of the data processing or operation, the processor 210 may store a command or data received from another component (e.g., the I/F 310) in the memory 220 (e.g., a volatile memory). As at least a part of the data processing or operation, the processor 210 may process commands or data stored in the memory 220 (e.g., a volatile memory). As at least a part of the data processing or operation, the processor 210 may store data of the result of processing the commands or data in the memory 230 (e.g., a non-volatile memory).

The memory 220 may store various data used by at least one component (e.g., the processor 210 and/or the I/F 310) of the electronic device 200. The data may include, e.g., input data or output data for software (e.g., a program) and related commands. The memory 220 may store at least one AI model (e.g., LLM, large vision models (LVM) or large multi-modal models (LMM)) for instance execution.

The memory 220 may store at least one instruction. The processor 210 may execute at least one instruction stored in the memory 220. The at least one instruction, when executed by the processor 210, may enable the electronic device 200 to perform at least one operation. For example, as at least one instruction is executed by the processor 210, at least one other component may be controlled, and/or various data processing or operations may be performed. When an operation is performed by the processor 210, it may mean that the corresponding operation is performed, e.g., by one entity (e.g., a main processor) included in the processor 210. When an operation is performed, it may mean, e.g., that a specific operation is performed by a plurality of entities (e.g., a plurality of processors) (or by control). When a plurality of operations are performed, it may mean that, e.g., all of the plurality of operations are performed by one entity (e.g., the main processor 121 of FIG. 1). When a plurality of operations are performed, it may mean, e.g., that some of the plurality of operations are performed by at least one entity, and some remaining operations are performed by at least one other entity. At least one instruction enabling the execution of one or more operations may be stored in one memory, e.g., or may be distributed and stored in each of a plurality of memories.

In the electronic device 200, the AI system 320 may share resources (e.g., the data processing or computing capabilities) corresponding to some or all of at least one processor included in the processor 210 and/or resources (e.g., the data recording areas) corresponding to some or all of the memories 220. For example, the AI system 320 may be operated by at least one of the CPU 211, the GPU 212, and the NPU 213. For example, the AI system 320 may be allocated to a partial area of the memory 220 and performed independently by the CPU 211. For example, the AI system 320 may be allocated to a partial area of the memory 230 and performed independently by the GPU 212. For example, the AI system 320 may be allocated to a partial area of the memory 220 and performed independently by the NPU 213. For example, the AI system 320 may be allocated to a partial area of the memory 230 and performed in cooperation between (e.g., together with) the CPU 211 and the GPU 212. For example, the AI system 320 may be allocated to a partial area of the memory 230 and performed in cooperation between (e.g., together with) the CPU 211 and the NPU 213. For example, the AI system 320 may be allocated to a partial area of the memory 230 and performed in cooperation between (e.g., together with) the GPU 212 and the NPU 213. For example, the AI system 320 may be allocated to a partial area of the memory 230 and performed in cooperation between (e.g., together with) the CPU 211, the GPU 212, and the NPU 213. Various embodiments to be described below in the disclosure are not limited to a combination of components for performing the AI system 320 but may be implemented and/or applied based on any combination thereof.

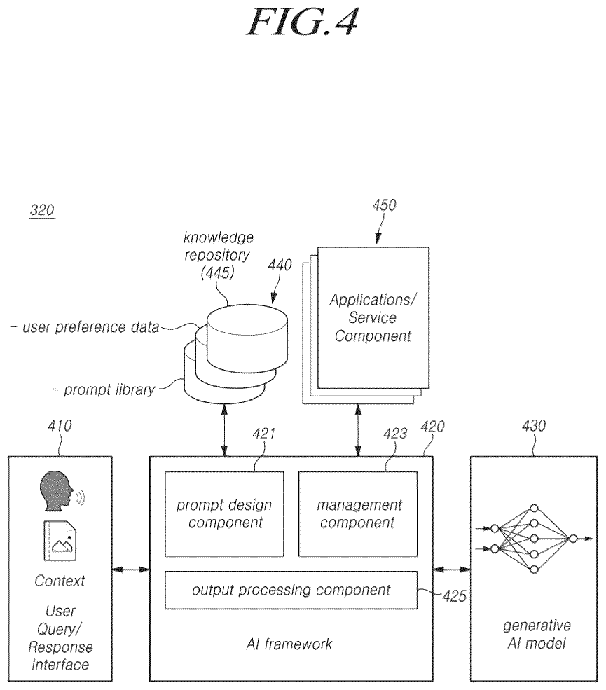

FIG. 4 is a block diagram illustrating an example configuration of an AI system (e.g., the AI system 320 of FIG. 3) capable of performing operations according to one or more embodiment(s). The AI system 320 may be a generative AI system but is referred to as an ‘AI system 320’ hereinafter.

Referring to FIG. 4, the AI system 320 may include a user query/response interface 410 (e.g., the I/F 310 of FIG. 3) (hereinafter referred to as an ‘I/F 410)’, an AI framework 420, a generative AI model 430 (hereinafter, referred to as an ‘AI model’), a database 440, or an application/service component 450.

The I/F 410 may receive an input (e.g., a user input or data obtained or generated by the terminal). The data obtained or generated by the terminal may include image or video data generated using the processor, and values transferred through sensors or sensor hubs (e.g., external illuminance, angle of the terminal, temperature of the display or terminal, size expansion/contraction information about the display, or images captured by the image sensor). The user input may be in the form of touch coordinates or stylus coordinates, images and/or videos obtained through the touch panel included in the display, or a digitizer. Further, context information may also be transmitted when the user input is transmitted. The context information may include various additional pieces of information at the time of the user input. For example, it may include information about the application being currently used by the user or location information about the user. Further, the user input may be a combination of the above-described natural language, image, sound, and context information. Further, the user input may be in an unnatural form, such as selecting a menu. The I/F 410 may output the results of the AI system 320 and/or the result of analyzing the inputs to the user. The output may be in natural-language forms or specific content forms or may be provided in the form, like an action requested by the user. The output may be provided in the form of a specific value designated by the user. The I/F 410 may output the result of the AI system 320 to the user. The output may be in natural-language forms or specific content forms or may be provided in the form, like an action requested by the user.

The AI framework 420 may receive the user's input and coordinate and control each component necessary to perform the user's intention based on the user's query. For example, the AI framework 420 may include a prompt design component 421, an API/plug-in management component 423, or an output modification component (or refiner component) 425.

The user input received by the I/F 410 may be transmitted to the prompt design component 421. The prompt design component 421 may use the user input to generate a prompt (e.g., the prompt 330 of FIG. 3) suitable for being input to the AI model 430 (e.g., LLM, LVM, or LMM). The prompt design component 421 may be an AI component that uses a machine learning algorithm or a neural network to develop a better prompt 330 over time. Although not illustrated, the prompt design component 421 may generate a prompt 330 by accessing a knowledge component including user preference data, a prompt library, and a prompt example based on the user input and may transfer the generated prompt 330 to the AI model 430.

When there is a request for additional information when transferring the user input as the input of the generative model, the management component 423 may perform a role of communicating with external information. The management component 423 establishes a channel capable of communicating with the outside of the AI interface through the API and allows access to various data sources (e.g., the knowledge repositors 445) through the established channel. When the application or service is required to perform an action based on a user's last input rather than on an intermediate result, the management component 423 may request the corresponding action from the application/service component 450 through the API. Information obtained from the outside may be used to generate the prompt 330 in the prompt design component 421 along with the user input or may be transferred as an input to the AI model 430.

The output modification component 425 may finely tune or reprocess the result output from the AI model 430. For example, the output modification component 425 may verify whether the content generated through the AI model 430 is irrelevant, contains biased content, or contains harmful content. The output modification component 425 may determine how much it matches the user's desired result and, if an additional process is required, proceed with the corresponding process. The output modification component 425 may further configure hints for avoiding unwanted outputs and provide them to the user.

The AI model 430 may generally mean an AI neural network that generates a new type of data depending on user input information. The AI model 430 may include a model for generating an image and/or a model for generating a language. The model for generating the image may include, e.g., a network or a variational auto encoder. The model for generating the image may be, e.g., a diffusion-based AI model using a variational auto encoder and a transformer structure. The model for generating the language may be a model trained to output the most statistically appropriate output value based on an input value. Representative examples include models such as CHAT-GPT 3 and CHAT-GPT 4. There is also an LMM as an AI model 430 that may recognize various types of data inputs such as text, images, voice, and videos and generate new data corresponding thereto.

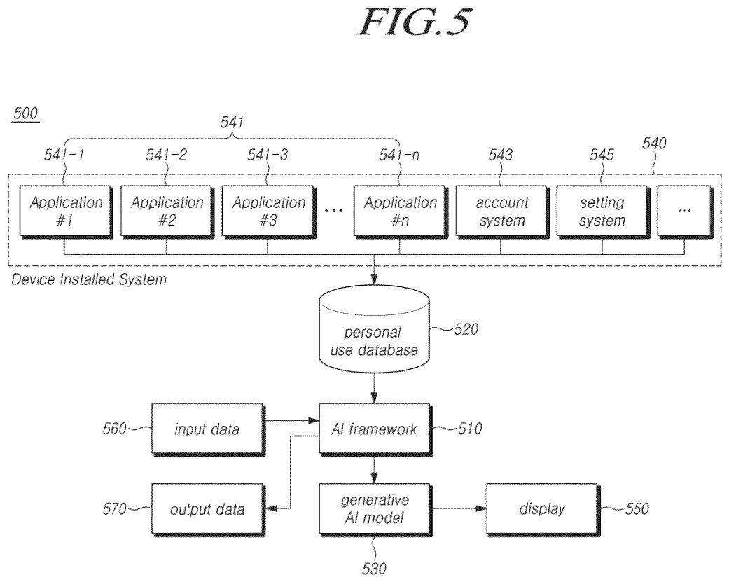

FIG. 5 is a block diagram illustrating an example configuration of a prompt generation/processing system 500 in an electronic device (e.g., the electronic device 101 of FIG. 1 or the electronic device 200 of FIG. 2) (hereinafter, referred to as an ‘electronic device 200’) according to one or more embodiment(s).

Referring to FIG. 5, the prompt generation/processing system 500 may obtain input data (e.g., the user query) 560. The prompt generation/processing system 500 may receive input data 560 as a natural language such as text or voice, for example. According to an example, the prompt generation/processing system 500 may receive the user query inputted as a voice through an AI platform (e.g., Bixby) or as a text through an input window (Search & Finder window).

The prompt generation/processing system 500 may analyze the input data 560 and obtain personal use data and/or log data within an accessible range based on the analysis result. To that end, the prompt generation/processing system 500 may determine (or identify) one or more target objects (e.g., application, account system, or setting system) to be accessed to obtain personal use data and/or log data based on the analysis result of the input data 560. The prompt generation/processing system 500 may obtain, e.g., personal use data and/or log data from an internal installation system 540. The prompt generation/processing system 500 may obtain, e.g., personal use data and/or log data from another electronic device in the network environment 100. The prompt generation/processing system 500 may obtain, e.g., personal use data and/or log data from a third-party application. The personal use data may be, e.g., personal data managed by the user through a specific application. For example, the personal use data may include personal schedule information managed through an application (hereinafter referred to as a ‘schedule management application’) that provides a schedule management function by the user. For example, the personal use data may include weather information about a specific date that the user identifies through an application that provides a weather forecast function (hereinafter referred to as a ‘weather forecast application’). For example, the personal use data may include data (e.g., photos or impressions) related to personal experiences registered in an application (hereinafter referred to as an “SNS application”) that provide social network service (SNS) functions by the user. The log data may be, e.g., data related to use records of the electronic device (e.g., the electronic device 200 of FIG. 2) by the user. The log data may be, e.g., data related to the record of use of a specific application by the user. For example, the log data may include information about the travel destination searched by the user using the electronic device 200. Hereinafter, personal use data and/or log data may be collectively referred to as ‘personal use data’ or ‘related data’ or ‘reference data’ for convenience of description.

According to an example, the prompt generation/processing system 500 may determine (e.g., identify) an application program having the highest priority among a plurality of application programs as a central application program. Depending on which application program the prompt generation/processing system 500 selects as the central application program among the plurality of application programs, a scenario for generating the prompt may be different. For example, the prompt generation/processing system 500 may assign priority to allow the running application program to be first selected as the central application program. For example, the prompt generation/processing system 500 may assign a relatively high priority to the related application based on recent use history (e.g., capture). The prompt generation/processing system 500 may analyze attributes of an application program (e.g., a map application program) installed additionally in response to the input data (e.g., a user query) 560 and determine (e.g., identify) whether to consider the application program related to the input data based on the analyzed result.

According to an example, the prompt generation/processing system 500 may determine (or identify) an order of accessing the plurality of application programs to obtain related data based on the input data 560. The prompt generation/processing system 500 may sequentially access the corresponding application program based on the determined access order to obtain related data. For example, the prompt generation/processing system 500 may access an application program that manages a ‘schedule’ to obtain schedule data and access an application program that forecasts ‘weather’ to obtain weather data.

According to an example, the prompt generation/processing system 500 may analyze the obtained data to determine (e.g., identify) an application program (e.g., including a third-party application) to be accessed next. The prompt generation/processing system 500 may access the determined application program to select a candidate query and then access the related additional application program to obtain additional data. In other words, the prompt generation/processing system 500 may additionally select or access an application program required step by step. For example, the prompt generation/processing system 500 may obtain weather data from the application program that forecasts the weather after referring to schedule data obtained from the application program that manages the schedule.

As an example, if the prompt generation/processing system 500 obtains input data of ‘What to eat for dinner tonight?’, it may determine at least one related application in response to the input data. The prompt generation/processing system 500 may analyze data (hereinafter referred to as ‘application data’) managed by the determined at least one related application. For example, the prompt generation/processing system 500 may select the schedule management application and/or the weather forecast application as a related application based on the keyword (or complex entry) “dinner tonight” included in the input data. The prompt generation/processing system 500 may access the schedule management application and obtain schedule data related to ‘dinner tonight’ within a range allowed to be accessed by the user. The prompt generation/processing system 500 may analyze the obtained schedule data and analyze application data such as participants or time in relation to the corresponding schedule. For example, the prompt generation/processing system 500 may select a schedule management application, a function of providing location information (e.g., a GPS function), and/or a map application as related applications based on the keyword ‘where’ included in the input data.

According to an example, the prompt generation/processing system 500 may determine (e.g., identify) one or more search words (e.g., words or tokens) reflecting a semantic distance based on the analysis result of personal use data and/or log data. Here, the search word may include one or more application search words (hereinafter referred to as ‘application search words’) and/or one or more recommendation search words (hereinafter referred to as ‘recommendation search words’). The application search word may be, e.g., a search word to be used for generating a prompt in the prompt generation/processing system 500. The recommendation search word may be, e.g., a search word that may be used or selected for reprocessing the prompt in the prompt generation/processing system 500. In the following description, the application search word may be used as a meaning to indicate one or more application search words, and the recommendation search word may be used as a meaning to indicate one or more recommendation search words. Here, the “semantic distance” may include measuring a conceptual difference between two or more objects within a given context. For example, the semantic distance is an indicator that quantifies the degree of dissimilarity or similarity between various concepts and may be used to identify semantic relationships. According to an example, it is possible to prepare an NLP capable of obtaining words based on dissimilarity or similarity with a specific word by mathematically expressing a semantic distance between numerous words in a multidimensional vector space. The NLP may predict the next word of a specific word based on the semantic distance between concepts or words in text or two or more texts, for example.

The prompt generation/processing system 500 may determine one or more recommendation search words in addition to the application search words based on the analysis result of the personal use data and/or log data.

According to an example, the prompt generation/processing system 500 may not limit the analysis target data to data related to the application program but may additionally consider related information provided from other electronic devices (e.g., the electronic devices 102 and 104 of FIG. 1) in the network environment (e.g., the network environment 100 of FIG. 1). The prompt generation/processing system 500 may analyze related information received from the other electronic devices 102 and 104 and determine one or more search words (e.g., words or tokens) reflecting the semantic distance based on the analysis result of the related information. The network environment 100 may be provided to support, e.g., a multi-device experience (MDE). The MDE may provide an environment that may provide a differentiated experience by combining AI and/or the IoT with several devices. In this case, functions and/or data related to IoT devices (or associated application programs) may be added to application program data to be referenced by prompt generation/processing system 500. For example, the prompt generation/processing system 500 may obtain (e.g., receive) temperature information from another electronic device in the network environment 100, such as an air conditioner, in response to the input data (e.g., a user query) 560 ‘I want it to be cool.’ In this case, the prompt generation/processing system 500 may consider (e.g., receive) the obtained temperature information to determine (e.g., identify) the search word.

According to an example, the prompt generation/processing system 500 may generate a prompt using the determined application search words. The prompt generation/processing system 500 may transfer the generated prompt, one or more application search words, or one or more recommendation search words as the output data 570. The prompt generation/processing system 500 may generate response data to the generated prompt, provide the generated response data as output data 570, or display it through the display 550.

According to an example, the prompt generation/processing system 500 may reconfigure the prompt by reflecting the removal of at least one application search word (hereinafter referred to as a ‘removal search word’) selected for removal from one or more application search words based on the input data 560. The prompt generation/processing system 500 may reconfigure the prompt by reflecting the addition of at least one recommendation search word (hereinafter referred to as an ‘additional search word’) selected for addition from one or more recommendation search words. The prompt generation/processing system 500 may reconfigure the prompt by removing at least one removal search word selected from one or more application search words and adding at least one additional search word selected from one or more recommendation search words. The prompt generation/processing system 500 may analyze personal use data and/or log data allowed to be accessed even when reconfiguring the prompt and reconfigure the prompt considering the analysis result. The prompt generation/processing system 500 may provide the reconfigured prompt, one or more application search words, or one or more recommendation search words as output data 570. The prompt generation/processing system 500 may generate response data to the reconfigured prompt, provide the generated response data as output data 570, or display it through the display 550.

According to an example, the prompt generation/processing system 500 may include an AI framework 510 (e.g., the AI framework 420 of FIG. 4), a personal use database 520, a generative AI model 530 (e.g., the generative AI model 430 of FIG. 4), or an installation system (device installed system) 540. The installation system (device installed system) 540 may include a default system (e.g., account system 543, or setting system 545) that is pre-installed as default for use of the electronic device 200, and/or a plurality of applications 541 (e.g., Application #1 541-1 to Application #n 541-n) that the user has selectively installed as needed. The default systems 543 and 545 may not be deleted. The application 541 included in the installation system may be selectively installed or deleted by the user.

According to an example, the personal use database 520 may include a storage space for managing personal use data and/or log data generated by the user accessing and using the installation system 540. The personal use database 520 may provide user use data and/or log data within a range allowed to be accessed. The access allowed range of the personal use database 520 may be set by, e.g., the user.

According to an example, the AI framework 510 may access the personal use database 520 based on the content of natural language (e.g., text or voice) included in the input data 560 to obtain personal use data and/or log data within the allowed range. The personal use data and/or log data may include information related to a result of using, recording, or searching on a specific application (e.g., the calendar application, the weather application, the health application, etc.) by the user. The AI framework 510 may perform the function of a prompt assistant manager. The function of the prompt assistant manager may include, e.g., a function of generating a prompt by determining at least one application to be accessed according to the semantic distance using personal use data and extracting and combining application data from at least one application considering priority. For example, the AI framework 510 may consider associations between applications when reading application data from the personal use database 520. The AI framework 510 may stepwise select an application (including a third party application) to access personal use data according to priority. For example, if “Please make a reservation at a restaurant” is input as input data 560, the AI framework 510 may access the weather forecast application to bring weather information about the schedule by referring to personal user data (e.g., family dinner at 7 p.m. this weekend) in the schedule management application or bring personal user data (e.g., information about the restaurant to be visited) in the SNS application.

According to an example, the generative AI model 530 may analyze the user's query in response to the prompt provided by the AI framework 510 and generate meaningful content as a response result based on the analysis result. The generative AI model 530 may output the generated response result through the display 550.

According to an example, an interface (e.g., the I/F 310 of FIG. 3) may be present between the AI framework 510 and the user. The I/F may provide priority application data to the user according to a semantic distance from personal use data based on the user's input data 560 (e.g., text input content). The priority application data may include application search words used to generate the prompt and/or recommendation search words that have not been used to generate the prompt but may be considered when reprocessing the prompt. The I/F may receive information related to search words (e.g., information about additional search words and/or removal search words) added and/or removed by the user as inputs and transfer the same to the AI framework 510.

According to an example, among the components, the applications may include all of cloud apps or applications that are directly installed in the electronic device 200 to store information in the electronic device 200 in their range. Further, even in the case of LLM, those on-device operated or operated on a server may all be included. Further, in the case of a third-party application, it is possible to provide data in the application to the LLM based on the data provided in the form of an API from the LLM system and operate the same. For example, in the LLM system in which a plurality of LLM models are operated, the LLM models may be sequentially used based on data to be processed. For example, the LLM system may separate and operate a first LLM to process personal data and a second LLM to process public data. In this case, the LLM system may operate the first LLM to obtain the primary result of using personal data and operate the second LLM to obtain the secondary result of using the obtained primary result.

As described above, if at least one of the data of the installed application 541 is selected, the electronic device 200 including the prompt generation/processing system 500 may generate a first prompt based on the user query and data of the selected at least one allowed application through the AI framework 510. The first prompt generated by the electronic device 200 may be transferred to the generative AI module 530. The electronic device 200 may output data used for generating the prompt among the generated first prompt and data of at least one allowed application. In this case, the result according to the first prompt may be received through the generative AI module 530 and displayed as well. The electronic device 200 supports the user to delete and/or add content related to the first prompt through the displayed information. The electronic device 200 may generate and display the processed second prompt by adding or excluding data of the allowed application in the first prompt in response to the user input. More specific examples will be described below in detail.

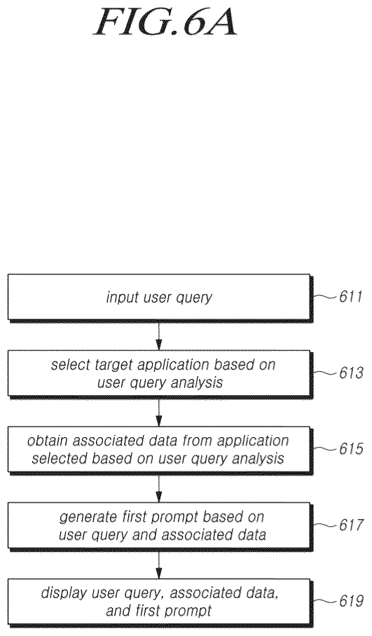

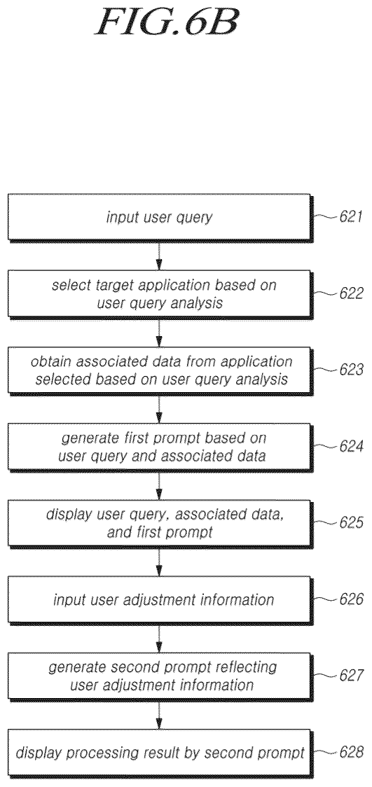

FIG. 6A is a control flowchart for generating an example prompt corresponding to a user query in an electronic device (e.g., the electronic device 101 of FIG. 1 or the electronic device 200 of FIG. 2) (hereinafter, referred to as an ‘electronic device 200’) according to one or more embodiment(s).

Referring to FIG. 6A, the electronic device 200 (e.g., the AI framework 510) may receive data (e.g., the input data 560 of FIG. 5) corresponding to the user query in operation 611. The input data may include, e.g., data of content requesting a search for desired information. The electronic device 200 may receive the input data 560 as a natural language such as text or voice. For example, the electronic device 200 may receive the user query inputted as a voice through an AI platform (e.g., Bixby) or as a text through an input window (Search & Finder window).

According to an example, the electronic device 200 (e.g., the AI framework 510) may analyze the user query in operation 613. For example, the electronic device 200 (e.g., the generative AI model 530) may convert the input data 560 that is natural language (e.g., text or voice) into machine language using the NLP function and recognize the query content desired by the user through the converted machine language. The electronic device 200 (e.g., the AI framework 510) may select one or more applications to be accessed to provide a response to the user query based on the analysis result in operation 613. For example, if the user query is analyzed as “What to eat for dinner tonight?”, the electronic device 200 (e.g., the AI framework 510) may determine (e.g., identify) at least one related application in response to the analysis result. For example, the electronic device 200 (e.g., the AI framework 510) may determine (e.g., identify) the schedule management application and/or the weather forecast application as related applications based on the keyword (or a complex entry) “dinner tonight” according to the analysis result. For example, the electronic device 200 (e.g., the AI framework 510) may select a schedule management application, a function of providing location information (e.g., a GPS function) and/or a map application as related applications based on the keyword ‘where’ according to the analysis result.

According to an example, in operation 615, the electronic device 200 (e.g., the AI framework 510) may access one or more applications (e.g., a schedule management application, and/or a weather forecast application) selected based on the analysis result of the user query to obtain application data corresponding to the user query within a range that the user allows access. For example, the electronic device 200 (e.g., the AI framework 510) may access the schedule management application and obtain schedule data which is application data related to ‘dinner tonight’ within a range allowed to be accessed by the user. For example, the electronic device 200 (e.g., the AI framework 510) may access the function (e.g., a GPS function) providing location information and/or the map application within the range allowed for access by the user to obtain data regarding the restaurant and/or location which is the application data related to ‘place for dinner’ based on the analysis result ‘where.’

According to an example, the electronic device 200 (e.g., the AI framework 510) may generate a first prompt based on associated data which is the analyzed user query and the obtained application data in operation 617. For example, the electronic device 200 (e.g., the AI framework 510) may analyze the associated data allowed for access. The electronic device 200 (e.g., the AI framework 510) may extract the application search words or recommendation search words reflecting the semantic distance based on the analysis result of the associated data. For example, the electronic device 200 (e.g., the AI framework 510) may generate the first prompt based on the search words obtained based on the associated data and the user query (e.g., What to eat for dinner tonight?). For example, if the schedule data ‘family dinner at 7 PM’ and the visited SNS data ‘steakhouse in Yangjae’ have been obtained as the associated data, the electronic device 200 (e.g., the AI framework 510) may obtain the search words ‘7 PM,’ ‘family,’ ‘Yangjae,’ and ‘steakhouse.’ The electronic device 200 (e.g., the AI framework 510) may determine (e.g., identify) all or some of the obtained search words as application search words. For example, if all of the obtained search words are determined (e.g., identified) as the application search words, the electronic device 200 (e.g., the AI framework 510) may generate a first prompt ‘Make a reservation at a steakhouse in Yangjae for family dinner at 7 PM tonight.’ In this case, the application search words may be determined as, e.g., ‘7 PM,’ ‘family,’ ‘dinner,’ ‘Yangjae,’ and ‘steakhouse.’ For example, if some of the obtained search words are determined as the application search words, the electronic device 200 (e.g., the AI framework 510) may generate a first prompt ‘Make a reservation at a steakhouse in Yangjae at 7 PM tonight.’ In this case, the application search words may be determined as, e.g., ‘7 PM,’ ‘Yangjae,’ and ‘steakhouse,’ and the recommendation search words may be determined as, e.g., ‘family’ and ‘dinner.’ Other examples of the first prompt are described below in detail.

According to an example, the electronic device 200 (e.g., the AI framework 510) may output the user query, associated data (e.g., application search words and/or recommendation search words), and the first prompt in operation 619. The electronic device 200 (e.g., the AI framework 510) may display, e.g., the user query, associated data (e.g., application search words and/or recommendation search words), and first prompt as visual information on the display. The electronic device 200 (e.g., the AI framework 510) may output the user query, associated data (e.g., application search words and/or recommendation search words), and the first prompt as auditory information through an audio output means (e.g., a speaker).

For example, the electronic device 200 (e.g., the generative AI model 530) may display the processing result of the AI model for the user's query, i.e., the search result, through the display (e.g., the display 550 of FIG. 5), or output the same as an audible signal (e.g., the output data 570) through the audio output means. The overall operation for obtaining a processing result corresponding to the user query may be performed by the generative AI model 530. For example, the electronic device 200 (e.g., the generative AI model 530) may display the processing result of the AI model for the first prompt, i.e., the search result, through the display (e.g., the display 550 of FIG. 5), or output the same as an audible signal (e.g., the output data 570) through the audio output means. The overall operation for obtaining a processing result corresponding to the first prompt may be performed by the generative AI model 530.

FIG. 6B is a control flowchart for (e.g., the electronic device 101 of FIG. 1 or the electronic device 200 of FIG. 2) (hereinafter, referred to as an ‘electronic device 200’) performing an example response of an AI model corresponding to a user query according to one or more embodiment(s).

According to an example, in operations 621 to 625 of FIG. 6B, the operation of the electronic device 200 generating the first prompt in response to the user query is substantially the same as operations 611 to 619 described with reference to FIG. 6A, and thus a detailed description thereof is omitted.

According to an example, in operation 626, the electronic device 200 may receive user adjustment information. The user adjustment information may be information that may be considered when reprocessing the first prompt. For example, the user adjustment information may be information about one or more application search words to be excluded when reprocessing the prompt among the application search words. The user adjustment information may be information about one or more recommendation (or recommended) search words to be added when reprocessing the prompt among the recommendation search words. For example, the user adjustment information may be information about one or more application search words to be excluded when reprocessing the prompt among the application search words or one or more recommendation (or recommended) search words to be added when reprocessing the prompt among the recommendation search words. For example, the electronic device 200 may propose an application to be additionally considered in order to reprocess the first prompt. For example, the electronic device 200 may designate an application to be additionally considered by the user for reprocessing the first prompt. For example, the electronic device 200 may propose to additionally consider application data of a specific application in order to reprocess the first prompt. For example, the electronic device 200 may request that the user additionally consider application data that may be obtained by accessing a specific application for reprocessing the first prompt.

According to an example, in operation 627, the electronic device 200 may reprocess the first prompt by reflecting (e.g., considering or applying) user adjustment information to generate a second prompt. The second prompt may be reprocessed to more accurately reflect the user's intention. According to one example, the reprocessing of the first prompt may be performed in response to removing one or more of the application search words (e.g., rainy day, family, four, or lunch) reflected (e.g., considered or applied) to generate the current prompt (e.g., recommend a good restaurant near Yangjae Station for a family of four for lunch). For example, the reprocessing of the first prompt may be performed in response to adding one or more recommendation search words among the recommendation search words (e.g., cold day, friend, two, snack, or near Seocho-dong) that may be considered to replace or newly reflect the application search word although not reflected to generate the current prompt (e.g., Recommend a good restaurant near Yangjae Station for a family of four for lunch on a rainy day). According to an example, the reprocessing of the first prompt may be performed, e.g., in response to the removal of one or more application search words and the addition of one or more recommendation search words. Examples of reprocessing the prompt by reflecting user adjustment information are described below in greater detail.

According to an example, in operation 628, the electronic device 200 may obtain (e.g., receive) the processing result of the AI model by the second prompt and output the obtained processing result. The electronic device 200 may output the second prompt, application search words used to generate the second prompt, and/or recommendation search words that have not been used at the time of generation of the second prompt but may be selected for further processing. If user adjustment information is input in response to the output second prompt, application search words, and/or recommendation search words, the electronic device 200 may reprocess the second prompt.

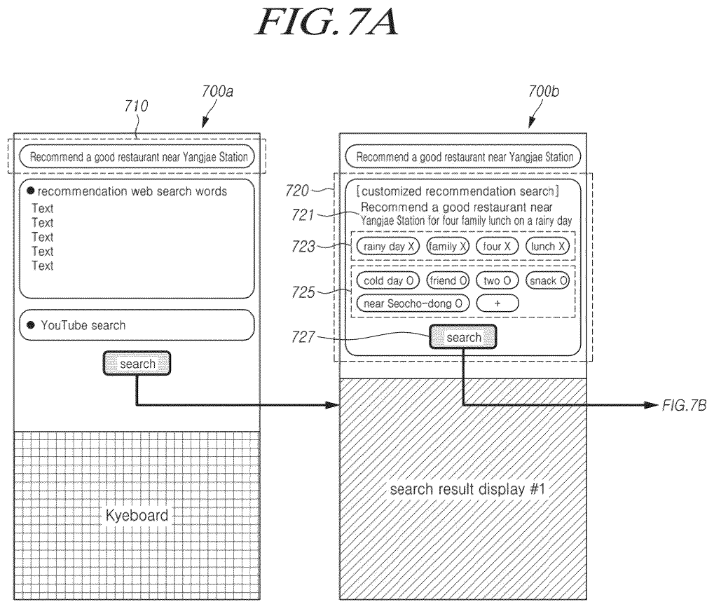

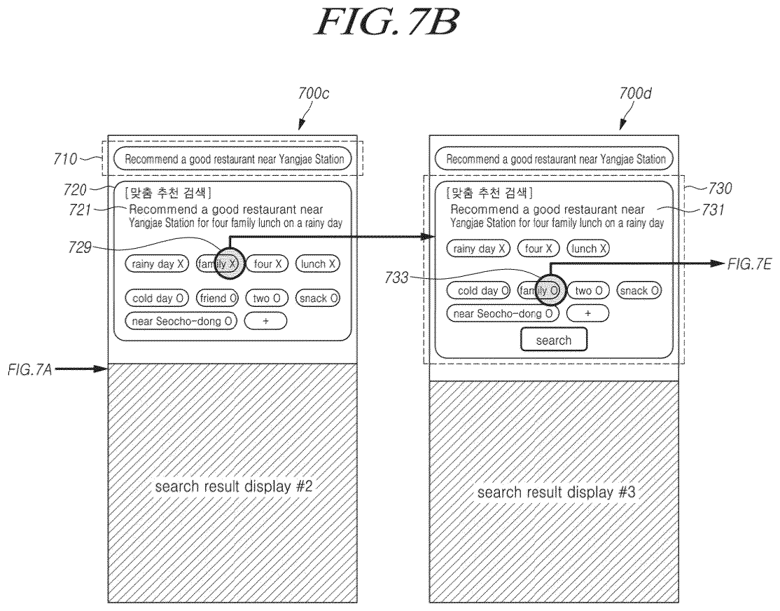

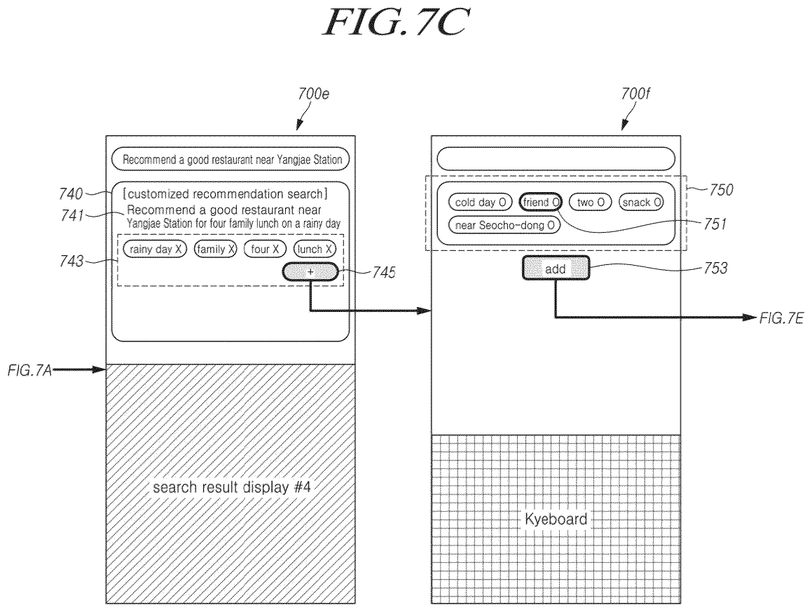

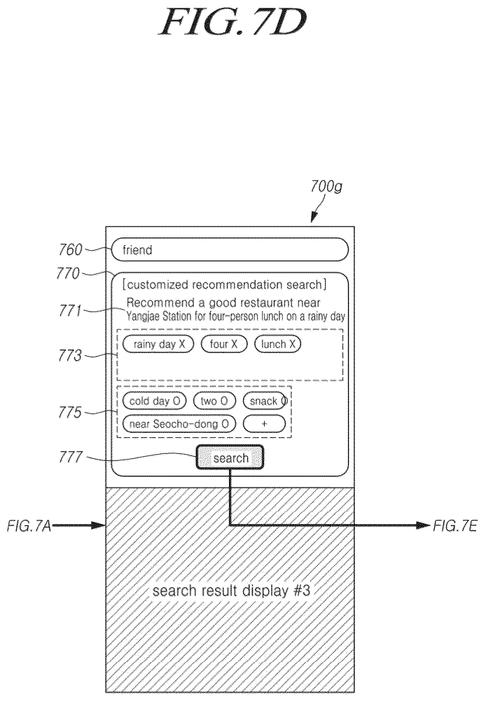

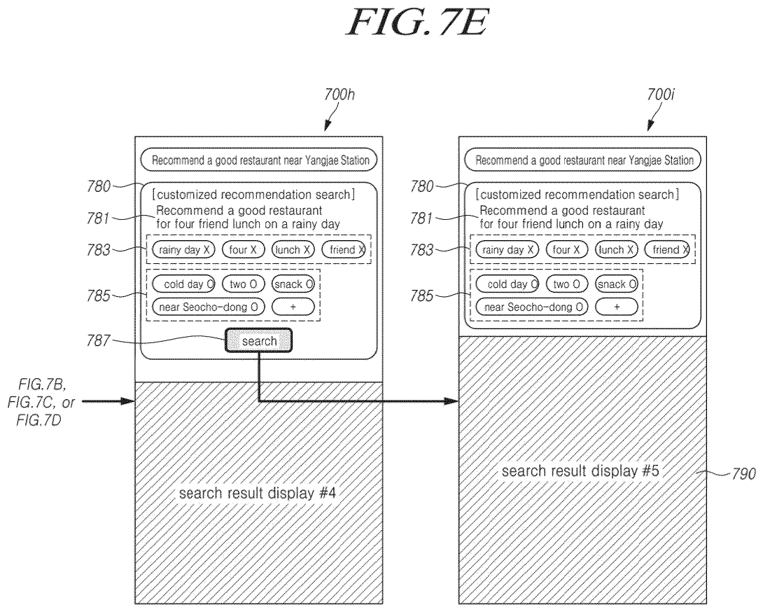

FIGS. 7A to 7E are views illustrating an example user interface (UI) (hereinafter, referred to as a ‘prompt generation UI’) for an electronic device (e.g., the electronic device 101 of FIG. 1 or the electronic device 200 of FIG. 2) (hereinafter, referred to as an ‘electronic device 200’) to generate a prompt (e.g., the prompt 330 of FIG. 3) according to one or more embodiment(s).

The prompt generation UI may include a prompt generation screen activated to generate a prompt or a prompt editing screen activated to edit the prompt. In the prompt generation screen or the prompt editing screen, screen configurations or items may be used differently for each situation, or arrangement positions may be modified. The prompt generation UI may include a search result display screen in which a search result generated based on analysis of an AI model (e.g., the generative AI model 430 of FIG. 4) is displayed in response to the user query or the prompt.

Referring to FIG. 7A, the electronic device 200 may output a first prompt editing screen 700b in response to the user query (e.g., Recommend a good restaurant near Yangjae Station) input on the prompt generation screen 700a.

According to an example, the prompt generation screen 700a may include an input window 710 for inputting the user query or a search word. The prompt generation screen 700a may further include a window for suggesting a search word that may be combined with information (e.g., the user query) input to the input window 710, a window for recommending an application to be used for a search, or a window for displaying one or more input search words. For example, the user may enter a query content (e.g., Recommend a good restaurant near Yangjae Station) into the input window 710 and select an indicator (e.g., a search icon) requesting a response. In the input window 710a, the user query or search word may be input by voice other than text. In the input window 710, the user query or search word input by voice rather than text may be possible based on an AI platform (e.g., Bixby). In the input window 710, the user may directly input the user query or search word but may also remotely input the same by an external electronic device (e.g., the electronic devices 102 or 104 of FIG. 1).

According to an example, the electronic device 200 may generate a first prompt 721 (e.g., Recommend a good restaurant near Yangjae Station for a family of four for lunch on a rainy day) in response to the user query input. The electronic device 200 may be insufficient to generate the first prompt 721 only with information that may be obtained by analyzing the input user query. In this case, the electronic device 200 may determine (e.g., identify) one or more applications for obtaining additional information based on the result of analyzing the user query. The electronic device 200 may obtain (e.g., receive) related data (or application data) necessary to generate the first prompt 721 from one or more applications determined based on the result of analyzing the user query. In this case, the related data that may be obtained from one or more applications may be data of an application allowed to be used by the user.

According to an example, the electronic device 200 may obtain the first search words 723 and 725 that may be considered to generate the first prompt 721 corresponding to the user query, based on related data. The first search words 723 and 725 may include, e.g., first application search words 723 and/or first recommendation search words 725. In order to obtain the search words 723 and 725, the electronic device 200 may analyze the user query and determine (e.g., identify) one or more applications for obtaining related data based on the analysis result. For example, the electronic device 200 may obtain (e.g., receive) the first application search words 723 (e.g., rainy day, family, 4, or lunch) used to generate the first prompt 721. For example, the electronic device 200 may obtain first recommendation search words 725 (e.g., cold day, friend, two, snack, or near Seocho-dong) that were not used to generate the first prompt 721 but could be considered to reconstruct the first prompt 721. The electronic device 200 may determine (e.g., identify) first search words (e.g., first application search words 723 and/or first recommendation search words 725) based on information obtained by analyzing the user query and/or information obtained from one or more applications.

For example, the AI model (e.g., the generative AI model 430 of FIG. 4) may obtain first application search words and/or first recommendation search words by analyzing the user query and/or information obtained from one or more applications. For example, the AI model 430 may obtain information related to the user query by analyzing data of an application allowed for access in the electronic device 200. For example, after obtaining access permission from the user, the AI model 430 may access data of an application not allowed for access in the electronic device 200 to analyze related data and additionally obtain information related to the user query based on the analysis result. The electronic device 200 may generate a search result corresponding to the user query using the AI model 430. The electronic device 200 may output the first prompt editing screen 700b using the search result, the first prompt 721, the first application search words 723, or the first recommendation search words 725, in response to the user query.

According to an example, the first prompt editing screen 700b may include a first prompt editing window 720. The first prompt editing window 720 may include items for editing the first prompt 721. For example, the first prompt editing window 720 may display the first prompt 721 (e.g., Recommend a good restaurant near Yangjae Station for a family of four for lunch on a rainy day), the first application search words 723 (e.g., rainy day, family, four, or lunch), or first recommendation search words 725 (e.g., cold day, friend, two, snack, or near Seocho-dong). A removal identifier (e.g., icon X) for excluding the corresponding application search word when reprocessing the prompt may be displayed near each of the first application search words 723 (e.g., rainy day, family, four, or lunch). An addition identifier (e.g., icon O) for adding the corresponding additional search word when reprocessing the prompt may be displayed near each of the first recommendation search words 725 (e.g., cold day, friend, two, snack, or near Seocho-dong). The first prompt editing window 720 may include an indicator 727 (e.g., a ‘search’ icon) for requesting a search for the first prompt 721. The first prompt editing screen 700b may include a window (e.g., search result display #1) for displaying a search result for the user query. For example, the user may select the search indicator 727 to request a search for the first prompt 721 displayed on the first prompt editing window 720.

Referring to FIG. 7B, if an indicator 727 requesting a search is input on the first prompt editing screen 700b, the electronic device 200 may output a second prompt editing screen 700c including the search result for the first prompt 721 (see the left drawing of FIG. 7B). For example, the second prompt editing screen 700c may include an input window 710 or a first prompt editing window 720. The first prompt editing window 720 may display the first prompt 721 (e.g., Recommend a good restaurant near Yangjae Station for a family of four for lunch on a rainy day), first application search words 723 (e.g., rainy day, family, four, or lunch), or first recommendation search words 725 (e.g., cold day, friend, two, snack, or near Seocho-dong).

According to an example, if at least one additional search word and/or at least one removal search word is selected in the first prompt editing window 720, the electronic device 200 may reprocess the first prompt 721 by reflecting the selected at least one additional search word and/or at least one removal search word. The electronic device 200 may output a prompt editing screen including the search result for the reprocessed prompt.

For example, if at least one of the first application search words 723 is selected as a removal search word (e.g., family 729) in the first prompt editing window 720, the electronic device 200 may reprocess the first prompt 721 into a second prompt 731 (e.g., Recommend a good restaurant near Yangjae Station for a family of four for lunch on a rainy day) by reflecting (e.g., considering or applying) the selected at least one removal search word. The electronic device 200 may output a third prompt editing screen 700d including the second prompt editing window 730 (see the right drawing of FIG. 7B). The second prompt editing window 730 may include the reprocessed second prompt 731, second application search words (e.g., rainy day, four, or lunch), or second recommendation search words 725 (e.g., cold day, friend, two, snack, or near Seocho-dong). An addition identifier (e.g., icon O) for adding the corresponding recommendation search word when reprocessing the prompt may be displayed near each of the second recommendation search words 725. The user may select, e.g., a search word to be added from among the second recommendation search words 725. For example, the user may select ‘friend 733’, which is one of the second recommendation search words 725 (e.g., cold day, friend, two, snack, or near Seocho-dong). In this case, the electronic device 200 may output the seventh prompt editing screen 700h of FIG. 7E.

Referring to FIG. 7C, if an indicator 727 requesting a search is input on the first prompt editing screen 700b, the electronic device 200 may output a fourth prompt editing screen 700e including the search result for the first prompt 721 (see the left drawing of FIG. 7C). For example, the fourth prompt editing screen 700e may include an input window 710 or a third prompt editing window 740. The third prompt editing window 740 may include the third prompt 741 (e.g., Recommend a good restaurant near Yangjae Station for a family of four for lunch on a rainy day), third application search words 743 (e.g., rainy day, family, four, or lunch), and/or an indicator 745 (e.g., ‘+’ icon) requesting to add a search word. As the indicator 745 requesting to add a search word, a hardware such as a microphone or a camera in addition to the ‘+’ icon may be used to request the addition of a search word. For example, if the ‘+’ icon requesting the addition of a search word is pressed, the electronic device 200 may display an identifier corresponding to a microphone and/or camera button and, when the corresponding identifier is selected by the user, receive a search word to be added through voice or image recognition when the identifier is selected by the user.

According to an example, if an indicator 745 (e.g., a ‘+’ icon) requesting the addition of a search word is input on the fourth prompt editing screen 700e, the electronic device 200 may output a fifth prompt editing screen 700f including a search word addition window 750 (see the right drawing of FIG. 7C). According to an example, the fifth prompt editing screen 700f may include a search word addition window 750 and/or an indicator 983 (e.g., an ‘add’ icon) that may request addition. Third recommendation search words (e.g., cold day, friend, two, snack, or near Seocho-dong) for addition may be displayed in the search word addition window 750. An addition identifier (e.g., icon O) for adding the corresponding recommendation search word when reprocessing the prompt may be displayed near each of the third recommendation search words. The user may, e.g., select a search word (e.g., friend) to be added in the search word addition window 750. The user may select an indicator 753 (e.g., ‘add’ icon) that may request addition after selecting one (e.g., friend) from among the third recommendation search words (e.g., cold day, friend, two, snack, or near Seocho-dong). In this case, the electronic device 200 may output the seventh prompt editing screen 700h of FIG. 7E.

Referring to FIG. 7D, if an indicator 727 requesting a search is input on the first prompt editing screen 700b, the electronic device 200 may output a sixth prompt editing screen 700g including the search result for the first prompt 721 (see the left drawing of FIG. 7D). For example, the sixth prompt editing screen 700g may include an input window 760 or a fourth prompt editing window 770. The fourth prompt editing window 770 may include the fourth prompt 771 (e.g., Recommend a good restaurant near Yangjae Station for a family of four for lunch on a rainy day) substantially identical to the first prompt 721, fourth application search words 773 (e.g., rainy day, family, four, or lunch), fourth recommendation search words 775 (e.g., cold day, two, snack, or near Seocho-dong), and/or an indicator 777 (e.g., a ‘search’ icon) for requesting a search.

According to an example, the electronic device 200 may directly input a search word to be added to the input window 760 on the sixth prompt editing screen 700g. For example, the user may select an indicator 777 (e.g., a ‘search’ icon) that may request a search after entering ‘friend’ as a search word to be added to the input window 760. In this case, the electronic device 200 may output the seventh prompt editing screen 700h of FIG. 7E.

Referring to FIG. 7E, if a recommendation search word is requested to be added on the third prompt editing screen 700d or the fifth prompt editing screen 700f, the electronic device 200 may output the seventh prompt editing screen 700h (see the left drawing of FIG. 7E). For example, the seventh prompt editing screen 700h may include an input window 710 or a fifth prompt editing window 780. The fifth prompt editing window 780 may display the fifth prompt 781 (e.g., Recommend a good restaurant near Yangjae Station for four friend lunch on a rainy day), fifth application search words 783 (e.g., rainy day, four, lunch, or friend), or fifth recommendation search words 785 (e.g., cold day, two, snack, or near Seocho-dong).

According to an example, when at least one additional search word and/or at least one removal search word is selected in the fifth prompt editing window 780, the electronic device 200 may reprocess the fifth prompt 781 by reflecting the selected at least one additional search word and/or at least one removal search word.

According to an example, when the search indicator 787 included in the fifth prompt editing window 780 is selected by the user, the electronic device 200 may generate a search result corresponding to the fifth prompt 781 using the AI model 430. In response to the fifth prompt 781, the electronic device 200 may output the eighth prompt editing screen 700i using the search result, the sixth prompt 751 substantially identical to the fifth prompt 781, the sixth application search words 783, or the sixth recommendation search words 785.

According to an example, the eighth prompt editing screen 700i may include the sixth prompt editing window 780. The sixth prompt editing window 780 may include items for editing the sixth prompt 781. For example, the sixth prompt editing window 780 may display the sixth prompt 781 (e.g., Recommend a good restaurant near Yangjae Station for four friend lunch on a rainy day), sixth application search words 783 (e.g., rainy day, four, lunch, or friend), or sixth recommendation search words 785 (e.g., cold day, two, snack, or near Seocho-dong). A removal identifier (e.g., icon X) for excluding the corresponding application search word, when reprocessing the prompt, may be displayed near each of the sixth application search words 783. An addition identifier (e.g., icon O) for adding the corresponding additional search word, when reprocessing the prompt, may be displayed near each of the sixth recommendation search words 785.

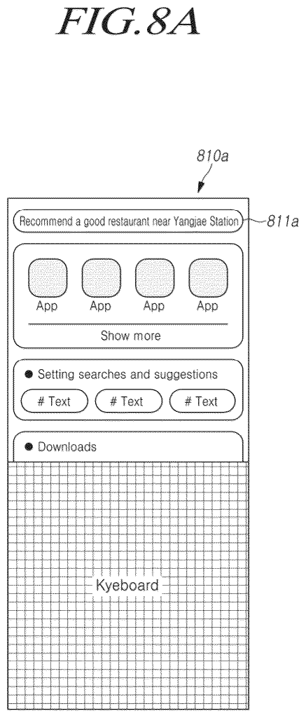

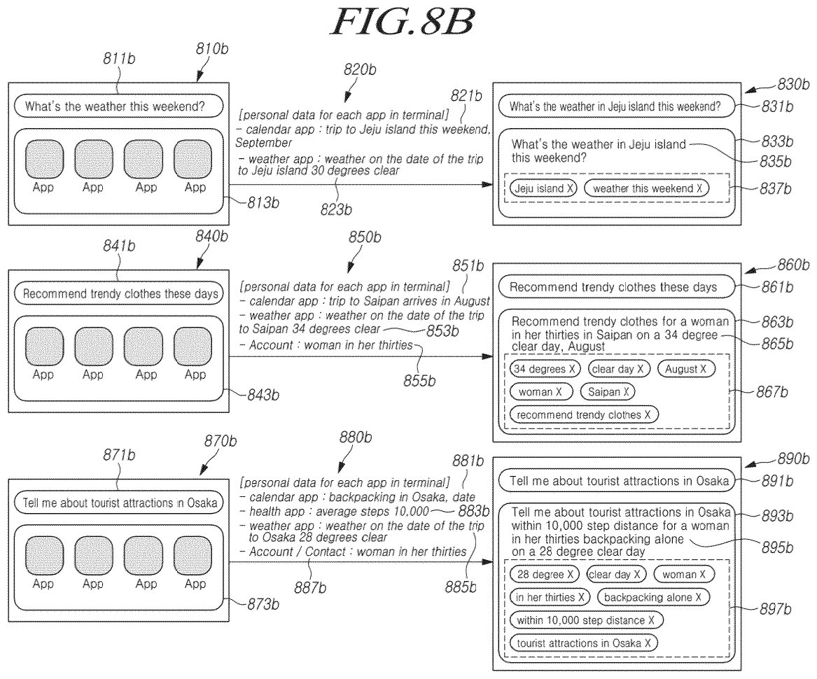

FIGS. 8A and 8B are views illustrating example user interface(s) (UI) (hereinafter, referred to as a ‘prompt generation UI’) for an electronic device (e.g., the electronic device 101 of FIG. 1 or the electronic device 200 of FIG. 2) (hereinafter, referred to as an ‘electronic device 200’) to generate a prompt (e.g., the prompt 330 of FIG. 3) according to one or more embodiment(s).

The prompt generation UI may include a prompt generation screen activated to generate a prompt or a prompt editing screen activated to edit the prompt. In the prompt generation screen or the prompt editing screen, screen configurations or items may be used differently for each situation, or arrangement positions may be modified. The prompt UI may include a search result display screen in which a search result generated based on analysis of an AI model (e.g., the generative AI model 430 of FIG. 4) is displayed in response to the user query or the prompt.

Referring to FIGS. 8A and 8B, the prompt generation screen 810a may include an input window 811a for inputting the user query or a search word. The prompt generation screen 810a may further include a window for displaying information input to the input window 811a and an identifier of one or more applications associated with the input information, or a window for displaying input one or more search words.

According to an example, the electronic device 200 may analyze the user query and select one or more applications to be accessed to provide a response to the user query based on the analysis result. For example, the applications to be accessed by the electronic device 200 may be differentiated based on the user query. For example, if the user query is analyzed (e.g., identified) as ‘What to eat for dinner tonight?’, the electronic device 200 may select the schedule management application and/or the weather forecast application as related applications based on the keyword (or a complex entry) “dinner tonight” according to the analysis result in response to the analysis result. Further, the electronic device 200 may select a schedule management application, a function of providing location information (e.g., a GPS function), and/or a map application as related applications based on the keyword ‘where’ according to the analysis result in response to the analysis result. For example, the electronic device 200 may simultaneously select a plurality of applications to obtain associated data in response to the user query. For example, the electronic device 200 may sequentially select the plurality of applications to obtain the associated data in response to the user query. For example, there may be a plurality of schedules obtained from the schedule management application based on the keyword (or complex entry) ‘dinner tonight’ according to the analysis result for the user query. In this case, the electronic device 200 needs to select one schedule among the plurality of schedules. For example, the electronic device 200 may select a schedule with a higher priority among the plurality of schedules. For example, the electronic device 200 may assign a relatively high priority to an earlier appointment (e.g., a schedule registered earlier) among the plurality of schedules. For example, the electronic device 200 may select one schedule considering the priority assigned to each appointment target (e.g., family, friend, or acquaintance)

According to an example, the electronic device 200 may analyze the user query 811b, 841b, or 871b and select one or more related applications according to the analysis result. The electronic device 200 may access the selected application and select at least one of information stored therein (e.g., app use log data allowed by the user, and data of installed applications) in association with the user query 811b, 841b, or 871b.

When the electronic device 200 selects internal information related to the query, the number of pieces of the selected information may be information allowed for access by the user. This may be determined based on the user's setting, a setting at the time of installation of the application, or the like. Alternatively, the electronic device 200 may request permission to access data from the user according to the result of the query analysis. The electronic device 200 may select information (e.g., schedule information stored in the calendar application) stored in the corresponding app and a specific application (e.g., the calendar app or weather app) allowed by the user among the information stored in application A or the application installed in association, for the user query.

According to an example, the electronic device 200 may identify queries 811b, 841b, and 871b input by the user on the prompt generation screens 810b, 840b, and 870b, and identify or select applications 813b, 843b, and 873b related to the identified user queries 811b, 841b, and 871b, and/or information 820b, 850b, and 880b stored in the applications. For example, if the user query 811b, 841b, and 871b “How's the weather this weekend?” is received, the electronic device 200 may analyze (e.g., identify) the user query 811b, 841b, and 871b to select the calendar application and/or the weather application, which are related applications. The electronic device 200 may identify the related application data 821b, 823b or 851b, 853b, 855b or 881b, 883b, 885b, 885b, and 887b among the stored information 820b, 843b, and 873b corresponding to the corresponding applications 813b, 843b, and 887b.

For example, the electronic device 200 may analyze the user query 811b ‘What's the weather like this weekend?’ input to the prompt generation screen 810b to select the calendar app and the weather app as the related applications and obtain first personal data 821b (e.g., trip to Jeju island this weekend and September) and second personal data 823b (e.g., clear, 30 degrees on the date of the trip to Jeju island) as the personal data 820b corresponding to the calendar app and the weather app, respectively. The electronic device 200 may analyze the first personal data 821b and the second personal data 823b and add the search words 837b (e.g., Jeju island and weather this weekend) to the user query 831b (e.g., What's the weather like this weekend?) to reconfigure the prompt 835b. The electronic device 200 may output a prompt editing screen 830b including the user query 831b and the prompt editing window 833b. The prompt editing window 833b may include the reconfigured prompt 835b (e.g., What's the weather like this weekend?) and search words 837b (e.g., Jeju island and weather this weekend).

According to an example, the electronic device 200 may analyze the user query 841b ‘Recommend some trendy clothes these days’ input to the prompt generation screen 840b to select the calendar app and the weather app and the account system as the related applications and obtain first personal data 851b (e.g., trip to Saipan arrives in August), second personal data 835b (e.g., clear, 34 degrees, and at the date of the trip to Saipan), and third personal data 855b (e.g., woman and in her thirties) as the personal data 850b corresponding to the calendar app, the weather app, and the account system, respectively. The electronic device 200 may analyze the first personal data 851b, the second personal data 853b, and the third personal data 855b and add search words 867b (e.g., 34 degrees, clear day, August, woman, Saipan, and recommend trendy clothes) to the user query 841b (e.g., Recommend trendy clothes these days) to reconfigure the prompt 865b. The electronic device 200 may output a prompt editing screen 860b including the user query 841b and the prompt editing window 863b. The prompt editing window 863b may include the reconfigured prompt 865b (e.g., Recommend trendy clothes these days for a woman in her thirties to wear in Saipan on a 34 degrees clear day and August) and the search words 867b (e.g., 34 degrees, clear day, August, woman, Saipan, and recommend trendy clothes).

For example, the electronic device 200 may analyze the user query 871b ‘Tell me about tourist attractions in Osaka” input to the prompt generation screen 870b, select the calendar app, the health app, the weather app, and the account system as related applications, and obtain first personal data 851b (e.g., backpacking in Osaka, and date), second personal data 883b (e.g., average steps 10,000), third personal data 885b (e.g., weather on the date of the trip to Osaka, 28 degrees, and clear), and fourth personal data 887b (e.g., in her thirties) as the personal data 880b corresponding to the calendar app, the health app, the weather app, and the account system, respectively. The electronic device 200 may analyze the first personal data 881b, the second personal data 883b, the third personal data 885b, and the fourth personal data 887b, and add the search words 897b (e.g., 28 degrees, clear day, 30s, in her thirties, woman, backpacking alone in Osaka, walking 10,000 steps or less, and Osaka tourist attractions) to the user query 871b to reconfigure the prompt 895b. The electronic device 200 may output a prompt editing screen 890b including the user query 871b and the prompt editing window 893b. The prompt editing window 893b may include the reconfigured prompt 895b (e.g., Tell me about tourist attractions in Osaka within 10,000-step distance for a woman in her thirties backpacking alone on a 28-degree, clear day for a woman), and search words 897b (e.g., 28 degrees, clear day, in her thirties, woman, backpacking alone, walking 10,000 steps or less, and Osaka tourist attractions).

According to an example, the number of applications selected by the electronic device 200 and stored data may be limited to a designated number. For example, the applications related to the query “Tell me about tourist attractions in Osaka” may be the calendar, health, weather, and account applications, but if the designated number is two, the calendar and weather applications may be selected. In this case, the electronic device 200 may determine the applications according to the priorities. Here, the priority may be determined based on various information such as association with the user query and the user's preference.

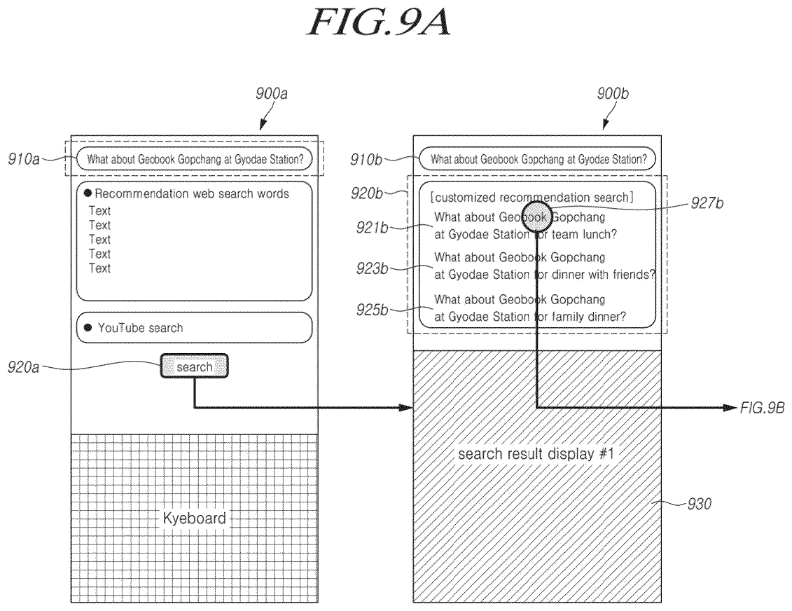

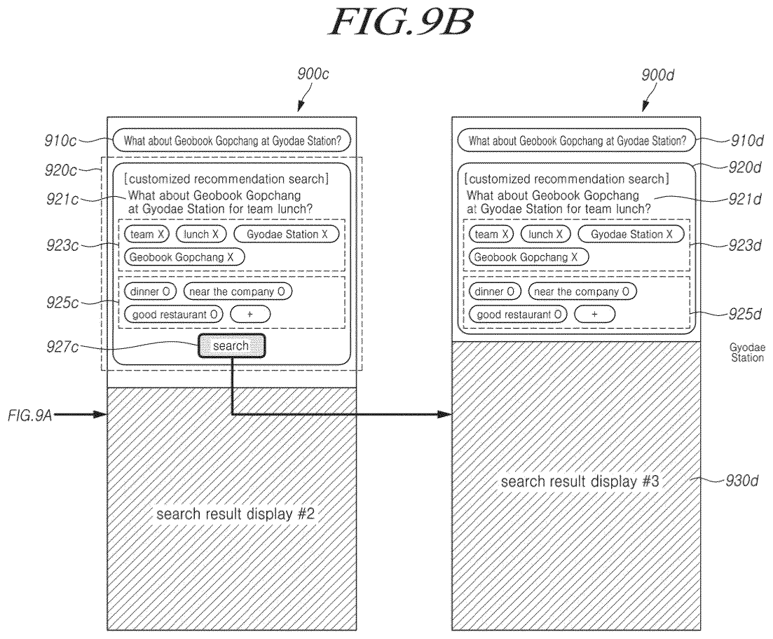

FIGS. 9A and 9B are views illustrating example user interface(s) (UI) (hereinafter, referred to as a ‘prompt generation UI’) for an electronic device (e.g., the electronic device 101 of FIG. 1 or the electronic device 200 of FIG. 2) (hereinafter, referred to as an ‘electronic device 200’) to generate a prompt (e.g., the prompt 330 of FIG. 3) according to one or more embodiment(s).

Referring to FIGS. 9A and FIG. 9B, the prompt generation UI may include a prompt generation screen 900a activated to generate a prompt or a prompt editing screen 900b, 900c, or 900d activated to edit the prompt. In the prompt generation screen 900a or the prompt editing screen 900b, 900c, or 900d, screen configurations or items may be used differently for each situation, or arrangement positions may be changed. The prompt UI may include a search result display screen 930b or 930d on which search results generated based on analysis of an AI model (e.g., the generative AI model 430 of FIG. 4) are displayed in response to the user query or prompt.

According to an example, the prompt generation screen 900a may include an input window 910a for inputting the user query or a search word. The prompt generation screen 900a may further include a window for suggesting a search word that may be combined with information input to the input window 910a, a window for recommending an application to be used for search, or a window for displaying one or more input search words. For example, the user may input a query content (e.g., What about Geobook Gopchang at Gyodae Station?) in the input window 910a and select an indicator 920a (e.g., a ‘search’ icon) requesting a response. In the input window 910a, the user query or search word input using voice (e.g., an AI platform) other than text may be possible. In the input window 910a, the user may directly input the user query or search word or input the same remotely by using an external electronic device (e.g., the electronic devices 102 or 104 of FIG. 1).

According to an example, the electronic device 200 may generate a plurality of recommendation prompts 921b, 923b, and 925b in response to the input of the user query. The electronic device 200 may output a prompt editing screen 900b including a plurality of generated recommendation prompts 1021b, 1023b, and 1025b. For example, the plurality of recommendation prompts 921b, 923b, and 925b may include ‘\textcircled{1} What about Geobook Gopchang at Gyodae Station for lunch?’ ‘\textcircled{2} What about Geobook Gopchang at Gyodae Station for dinner with friends?’ or ‘\textcircled{3} What about Geobook Gopchang at Gyodae Station for family dinner?’. For example, the user may select one 921b from the plurality of recommendation prompts 921b, 923b, and 925b (1027b). For example, the electronic device 200 may analyze the user query ‘What about Geobook Gopchang at Gyodae Station?’ and select one or more applications related to the user query (e.g., schedule management application, weather application, map application, and SNS application) based on the analysis results. The electronic device 200 may simultaneously select, e.g., the plurality of applications related to the user query. The electronic device 200 may sequentially select, e.g., the plurality of applications related to the user query. The electronic device 200 may obtain application data allowed for access by the user from one or more applications. The electronic device 200 may analyze the obtained application data to determine search words. The electronic device 200 may generate various recommendation prompts 1021b, 1023b, and 1025b by additionally reflecting at least one application search word selected from among the determined search words to the user query. For example, the electronic device 200 may variously select a reference application from among the selected applications and generate various recommendation prompts 1021b, 1023b, and 1025b therethrough.

According to an example, the electronic device 200 may obtain application search words (e.g., team, lunch, Gyodae Station, Geobook Gopchang) used in the selected recommendation prompt 921b (e.g., What about Geobook Gopchang at Gyodae Station for team lunch?). Although not used in the selected recommendation prompt 921b, the electronic device 200 may obtain recommendation search words (e.g., dinner, near the company, and good restaurant) that may be considered in order to reconfigure the selected recommendation prompt. The electronic device 200 may generate a search result corresponding to the selected recommendation prompt 921b using the AI model 430. The electronic device 200 may output the first prompt editing screen 900c using the search result, the selected recommendation prompt 921c, the application search words 923c, or the recommendation search words 925c in response to the selected recommendation prompt 921b.

According to an example, the first prompt editing screen 1000c may include a first input window 910c or a first prompt editing window 920c. Items for editing the first prompt 921c may be included in the first prompt editing window 920c. For example, the first prompt editing window 920c may display the first prompt 921c (e.g., What about Geobook Gopchang at Gyodae Station for team lunch?), the first application search words 923c (e.g., team, lunch, Gyodae Station, Geobook Gopchang), or the first recommendation search words 925c (e.g., dinner, near the company, good restaurant). A removal identifier (e.g., icon X) for excluding the corresponding application search word, when reprocessing the prompt, may be displayed near each of the first application search words 923c (e.g., company, lunch, Gyodae

Station, Geobook Gopchang). An addition identifier (e.g., icon O) for adding the corresponding additional search word when reprocessing the prompt may be displayed near each of the first recommendation search words 925c (e.g., dinner, near the company, good restaurant). The first prompt editing window 920c may include an indicator 927 (e.g., a ‘search’ icon) for requesting a search for the first prompt 921c. The first prompt editing screen 900c may include a window (e.g., search result display #2) for displaying a search result for the first prompt 921c. For example, the user may select the indicator 927c to request a search for the first prompt 921c displayed on the first prompt editing window 920c.

If an indicator 927c requesting a search is input on the first prompt editing screen 900c, the electronic device 200 may output a second prompt editing screen 910d including the search result for the first prompt 921c. According to an example, the second prompt editing screen 900d may include a second prompt editing window 920d. Items for editing the second prompt 921d may be included in the second prompt editing window 920d. For example, the second prompt editing window 920d may display the second prompt 921d (e.g., What about Geobook Gopchang at Gyodae Station for team lunch?), the second application search words 923d (e.g., team, lunch, Gyodae Station, Geobook Gopchang), or the second recommendation search words 925c (e.g., dinner, near the company, good restaurant). A removal identifier (e.g., icon X) for excluding the corresponding application search word, when reprocessing the prompt, may be displayed near each of the second application search words 923d. An addition identifier (e.g., icon O) for adding the corresponding recommendation search word, when reprocessing the prompt, may be displayed near each of the second recommendation search words 925d.

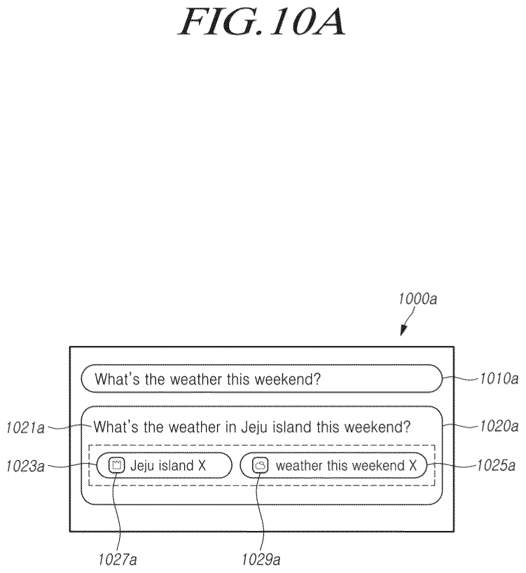

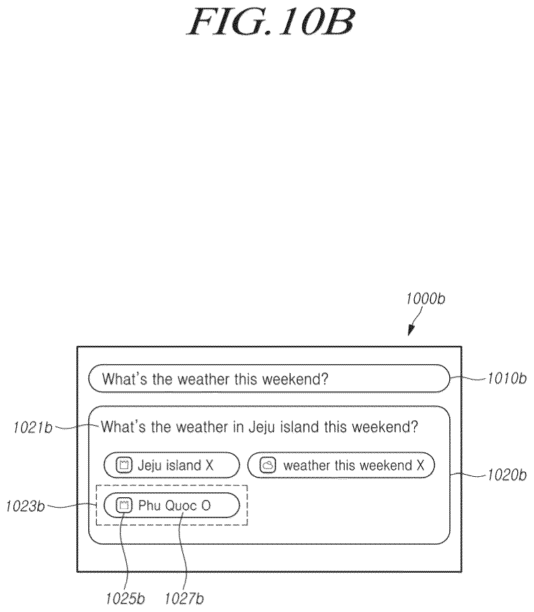

FIGS. 10A and 10B are views illustrating example user interface(s) displaying a search word for editing a prompt (e.g., the prompt 330 of FIG. 3) in an electronic device (e.g., the electronic device 101 of FIG. 1 or the electronic device 200 of FIG. 2) (hereinafter, referred to as an ‘electronic device 200’) according to one or more embodiment(s).

Referring to FIG. 10A, the prompt editing screen 1000a may include an input window 1010a or a prompt editing window 1020a capable of editing the prompt. For example, the input window 1010a may be an interface for inputting a user query (e.g., What's the weather like this weekend?). For example, the input window 1010a may be an interface for generating a prompt or inputting a search word to be added for reconfiguration. The prompt editing screen 1000a may be a user interface screen to provide editing of the prompt 1021a (e.g., the prompt 330 of FIG. 3). The prompt editing window 1020a may display the prompt 1021a (e.g., What's the weather like in Jeju Island this weekend?) or application search words (e.g., Jeju island 1023a), weather this weekend 1025a) for the prompt 1021a. The prompt 1021a may be generated by an AI model (e.g., a generative AI model 430 of FIG. 4) in response to the user query input to the input window 1010a. The prompt editing window 1020a may display identifiers 1027a and 1029a indicating applications related to the application search words 1023a and 1025a. For example, the identifiers 1027a and 1029a may be displayed near the corresponding application search words 1023a and 1025a. The identifiers 1027a and 1029a may indicate sources of the application search words 1023a and 1025a.

According to an example, in response to the user selecting the specific identifiers 1027a and 1029a displayed on the prompt editing window 1020a, the electronic device 200 may output corresponding information (e.g., Jeju Island weather information or Jeju travel itinerary information) by executing the application corresponding to the selected specific identifier.

Referring to FIG. 10B, the prompt editing screen 1000b may include an input window 1010b or a prompt editing window 1020b capable of editing the prompt. For example, the input window 1010a may be an interface for inputting a user query (e.g., What's the weather like this weekend?). For example, the input window 1010a may be an interface for generating a prompt or inputting a search word to be added for reconfiguration. The prompt editing screen 1000b may be a user interface screen to provide editing of the prompt 1021b (e.g., the prompt 330 of FIG. 3). The prompt editing window 1020b may display the prompt 1021b (e.g., What's the weather like in Jeju Island this weekend?), application search words (e.g., Jeju island, weather this weekend) for the prompt 1021b, and a recommendation search word 1023b (e.g., Phu Quoc 1027b) for reconfiguring the prompt 1021b. The prompt 1021a may be generated by an AI model (e.g., a generative AI model 430 of FIG. 4) in response to the user query input to the input window 1010a. The prompt editing window 1020b may display an identifier 1025b indicating an application related to the recommendation search word 1027b. For example, the identifier 1025b may be displayed near the corresponding recommendation search word 1027b. The identifier 1025b may indicate the source of the recommendation search word 1027b.

According to an example, in response to the user selecting the specific identifiers 1027a and 1029a displayed on the prompt editing window 1020a, the electronic device 200 may output corresponding information (e.g., Jeju Island weather information or Jeju travel itinerary information) by executing the application corresponding to the selected specific identifier.

As described above, the prompt editing window 1020b is output to display application information associated with information not used for prompt generation due to low priority. For example, the schedule information associated with the user's query “What's the weather like this weekend?” includes information about Jeju trip itinerary (e.g., family) and Phu Quoc itinerary (e.g., parents). In this case, ‘Jeju Island schedule information’ having a relatively high priority may be applied at the time of prompt generation. The ‘Phu Quoc trip itinerary information’ having a relatively low priority was not applied at the time of prompt generation but may be suggested as recommendation search words to be added.

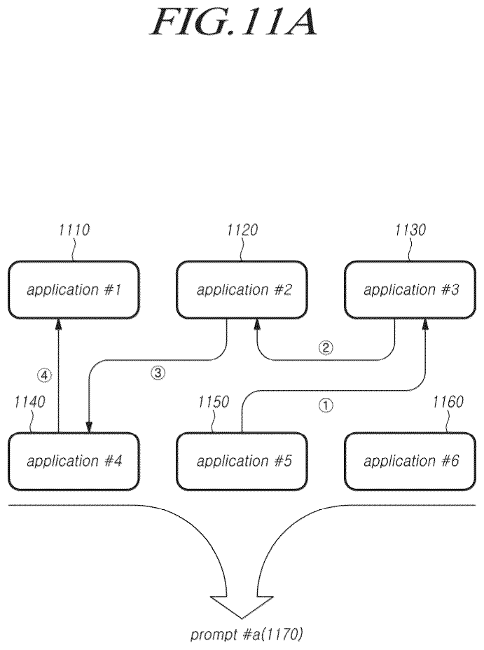

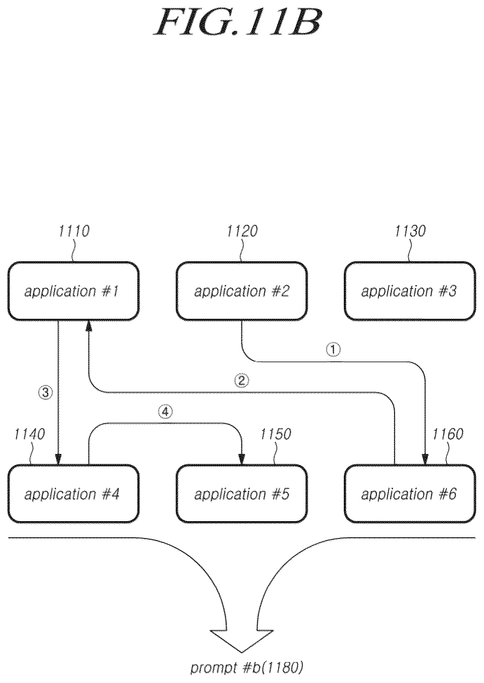

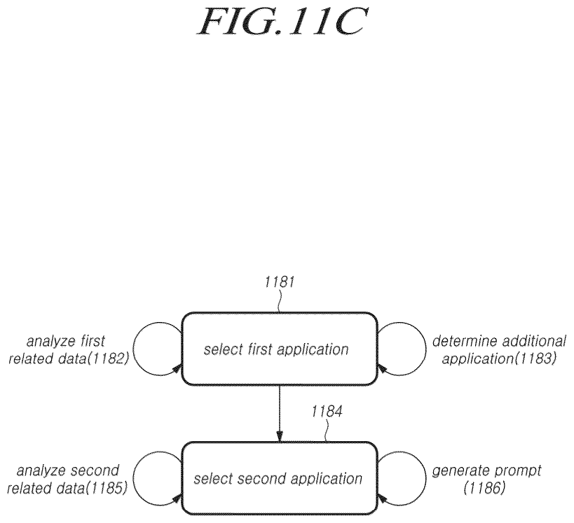

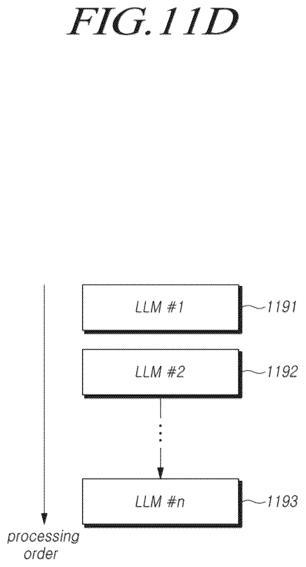

FIGS. 11A and 11B are views illustrating sequentially accessing example application(s) to generate a prompt in an electronic device (e.g., the electronic device 101 of FIG. 1 or the electronic device 200 of FIG. 2) (hereinafter, referred to as an ‘electronic device 200’) according to one or more embodiment(s).

The electronic device 200 (e.g., the AI framework 510 of FIG. 5) may determine a target object (e.g., an application, an account system, or a setting system) to be accessed to obtain associated data based on the analysis result of the user query 560. The electronic device 200 (e.g., the AI framework 510 of FIG. 5) may analyze the user query to assign priorities corresponding to the target objects to the target objects. The electronic device 200 (e.g., the AI framework 510 of FIG. 5) may assign priorities to the target objects for the purpose of generating prompts, for example. For example, a relatively high priority may be assigned to an application being executed. For example, the electronic device 200 (e.g., the AI framework 510 of FIG. 5) may assign the next priority to an application having high relevance to the application assigned the priority. The electronic device 200 (e.g., the AI framework 510 of FIG. 5) may assign the next priority to an application (e.g., a map application) having high relevance to the application assigned the priority, after the application is installed.

According to an example, the electronic device 200 (e.g., the AI framework 510 of FIG. 5) may determine an application program having the highest priority among a plurality of application programs as a central application program. The electronic device 200 (e.g., the AI framework 510 of FIG. 5) may have a different scenario for generating a prompt depending on which application program is selected as the central application program among the plurality of application programs. For example, the electronic device 200 (e.g., the AI framework 510 of FIG. 5) may assign priority to allow the running application program to be first selected as the central application program. For example, the electronic device 200 (e.g., the AI framework 510 of FIG. 5) may assign relatively high priority to the related application based on recent use history (e.g., capture). The electronic device 200 (e.g., the AI framework 510 of FIG. 5) may analyze attributes of an application program (e.g., a map application program) installed additionally in response to the input data (e.g., a user query) 560, and determine whether to consider the application program related to the input data based on the analyzed result.

Referring to FIG. 11A, the electronic device 200 (e.g., the AI framework 510 of FIG. 5) may determine the reference application to be first accessed as application #5 1150 in response to the user query. The reference application may be determined by the AI framework 510. The electronic device 200 may determine (e.g., identify) the application to be accessed considering the user query and the reference application, application #5 1150. For example, the electronic device 200 may obtain (e.g., receive) application data from the reference application, application #5 1150 and then determine (e.g., identify) the order of applications to be accessed as ‘application #3 1130→application #2 1120→application #4 1140→application #1 1110’. The application access order may be determined by the AI framework 510. In this case, the electronic device 200 may obtain the first application data from application #5 1150 to be accessed first. The electronic device 200 may obtain the second application data from application #3 1130 to be accessed second (\textcircled{1}). The electronic device 200 may obtain the third application data from application #2 1120 to be accessed third (\textcircled{2}). The electronic device 200 may obtain the fourth application data from application #4 1140 to be accessed fourth (\textcircled{3}).

The electronic device 200 may obtain the fifth application data from application #1 1110 to be accessed fifth (\textcircled{4}). According to an example, the electronic device 200 (e.g., the AI framework 510 of FIG. 5) may obtain (e.g., receive) application data from the corresponding application to be accessed and analyze the obtained application data to determine (e.g., identify) the application to be accessed next. For example, the electronic device 200 (e.g., the AI framework 510 of FIG. 5) may access the corresponding application to obtain and analyze the schedule data and, if recognizing that the analysis result is ‘family dinner appointment’, determine the application (e.g., an SNS application) capable of obtaining information about the restaurant frequently visited by the family as the application to be accessed next. An example in which the electronic device 200 determines an order of access of a plurality of selected applications for generating a prompt has been described above, and thus, may refer to the foregoing.

Referring to FIG. 11B, the electronic device 200 (e.g., the AI framework 510 of FIG. 5) may determine (e.g., identify) the reference application to be first accessed as application #2 1120 in response to the user query. The reference application may be determined by the AI framework 510. The electronic device 200 may determine (e.g., identify) the application to be accessed considering the user query and the reference application, application #2 1120. For example, the electronic device 200 may obtain (e.g., receive) application data from the reference application, application #2 1120, and then determine (e.g., identify) the order of applications to be accessed as ‘application #6 1160→application #1 1110→application #4 1140→application #5 1150’. The application access order may be determined by the AI framework 510. In this case, the electronic device 200 may obtain the first application data from application #2 1120 to be accessed first. The electronic device 200 may obtain the second application data from application #6 1160 to be accessed second (\textcircled{1}). The electronic device 200 may obtain the third application data from application #1 1110 to be accessed third (\textcircled{2}). The electronic device 200 may obtain the fourth application data from application #4 1140 to be accessed fourth (\textcircled{3}). The electronic device 200 may obtain the fifth application data from application #5 1150 to be accessed fifth (\textcircled{4}). According to an example, the electronic device 200 (e.g., the AI framework 510 of FIG. 5) may obtain application data from the corresponding application to be accessed and analyze the obtained application data to determine the application to be accessed next. For example, the electronic device 200 (e.g., the AI framework 510 of FIG. 5) may access a corresponding application to obtain and analyze weather data and, if recognizing that the analysis result is a ‘high chance of rainfall’, may access an application that may obtain schedule data and analyze whether there is a schedule that needs to be changed due to rain.

According to an example, the electronic device 200 (e.g., the AI framework 510 of FIG. 5) may analyze the application data corresponding to each of the applications accessed in a predetermined order and obtain (e.g., receive) associated data based on the semantic distance from the user query. The electronic device 200 (e.g., the AI framework 510 of FIG. 5) may determine a search word (e.g., an application search word and/or a recommendation search word) by referring to the associated data.

According to an example, the electronic device 200 (e.g., the AI framework 510 of FIG. 5) may generate a prompt (e.g., prompt #a 1170 or prompt #b 1180) that may be predicted (e.g., identified) from the user query based on the determined search word. For example, the user query may be ‘Recommend a good restaurant near Yangjae Station’, and the prompt #a 1170 generated by reflecting the application search words included in the search word may be ‘Recommend a good restaurant near Yangjae Station for a family of four for lunch on a rainy day’.

According to an example, the electronic device 200 (e.g., the generative AI model 530) may output the user query, the prompt (e.g., prompt #a 1170 or prompt #b 1180) and the search word (e.g., application search word and/or recommendation search word) through the display 550. The electronic device 200 (e.g., the generative AI model 530) may output the processing result for the user query through the display 550. A detailed example thereof is described below with reference to FIGS. 7A to 7E.

According to an example, if the user requests a search for the prompt (e.g., prompt #a 1170 or prompt #b 1180) output through the display 550, the electronic device 200 (e.g., the generative AI model 530) may output the processing result for the prompt (e.g., prompt #a 1170 or prompt #b 1180) through the display 550. A detailed example thereof is described below with reference to FIGS. 7A to 7E.

According to an example, if the user requests to remove an application search word output through the display 550, the electronic device 200 (e.g., the AI framework 510) may reconfigure a prompt in which the corresponding removal search word has been excluded from the prompt (e.g., prompt #a 1170 or prompt #b 1180). The electronic device 200 (e.g., the generative AI model 530) may output the user query, the reconfigured prompt, the application search words where the removal search word has been excluded, and/or the recommendation search word through the display 550. The electronic device 200 (e.g., the generative AI model 530) may output the processing result for the reconfigured prompt through the display 550. A detailed example thereof is described below with reference to FIGS. 7A to 7E.

According to an example, if the user requests to add a recommendation search word output through the display 550, the electronic device 200 (e.g., the AI framework 510) may reconfigure a prompt in which the corresponding additional search word has been applied to the prompt (e.g., prompt #a 1170 or prompt #b 1180). The electronic device 200 (e.g., the generative AI model 530) may output the user query, the reconfigured prompt, the application search words where the additional search word has been included, and/or the recommendation search words where the additional search word has been excluded through the display 550. The electronic device 200 (e.g., the generative AI model 530) may output the processing result for the reconfigured prompt through the display 550. A detailed example thereof is described below with reference to FIGS. 7A to 7E.

As described above, as identified in FIGS. 11A and 11B, the electronic device 200 may generate a different prompt depending on the determination (e.g., identification) of the reference application and access order. An example in which the electronic device 200 determines (e.g., identifies) an order of access of a plurality of selected applications for generating a prompt has been described above, and thus, may refer to the foregoing.

FIG. 11C is a view illustrating generating an example prompt by sequential applications in an electronic device (e.g., the electronic device 101 of FIG. 1 or the electronic device 200 of FIG. 2) (hereinafter, referred to as an ‘electronic device 200’) according to one or more embodiment(s).

Referring to FIG. 11C, the electronic device 200 (e.g., the AI framework 510) may select a first application as a reference application to obtain related data based on input data 560 which is a user query (1181). The electronic device 200 (e.g., the AI framework 510) may access the first application, obtain first related data and analyze the obtained first related data (1182). The electronic device 200 (e.g., the AI framework 510) may determine (e.g., identify) an additional application to be accessed next based on the analysis result (1183).

If a second application to be accessed next is selected, the electronic device 200 (e.g., the AI framework 510) may access the second application, obtain the second related data, and analyze the obtained second related data (1184, 1185). If there is no additional application to be accessed next based on the analysis result, the electronic device 200 (e.g., the AI framework 510) may generate a prompt based on the first related data and the second related data (1186).

FIG. 11D is a view illustrating sequentially processing an example user query or a prompt using a plurality of LLMs in an electronic device (e.g., the electronic device 101 of FIG. 1 or the electronic device 200 of FIG. 2) (hereinafter, referred to as an ‘electronic device 200’) according to one or more embodiment(s).

Referring to FIG. 11D, the electronic device 200 (e.g., the generative AI model 530) may operate a plurality of LLM models 1191, 1192, and 1193. The plurality of LLM models 1191, 1192, and 1193 may be operated on device, operated on a server, or distributed and operated on device and the server. According to an example, the electronic device 200 (e.g., the generative AI model 530) may sequentially use the LLM models 1191, 1192, and 1193 based on the data to be processed. For example, the electronic device 200 (e.g., the generative AI model 530) may provide the LLM models 1191, 1192, and 1193 to each separate and process data. For example, LLM #1 1191 and LLM #2 1192 may be provided to separate and process personal data and LLM #3 1193 may be provided to process public data. In this case, the electronic device 200 (e.g., the generative AI model 530) may allow LLM #1 1191, LLM #2 1192, and LLM #3 1193 to sequentially process the personal data and public data according to the processing order.

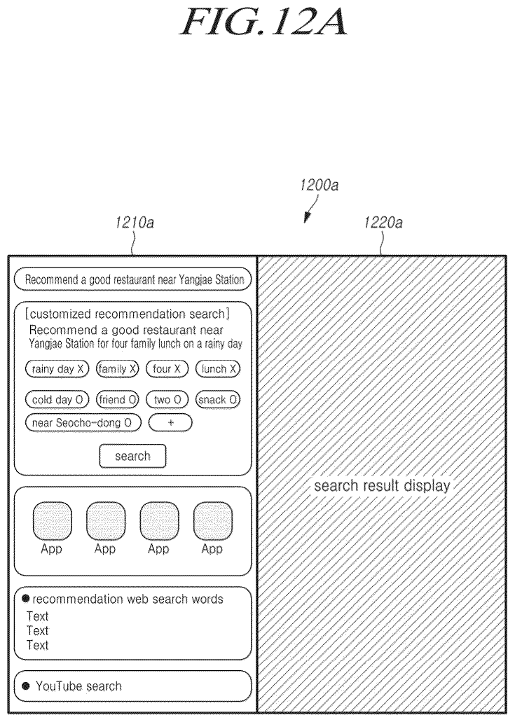

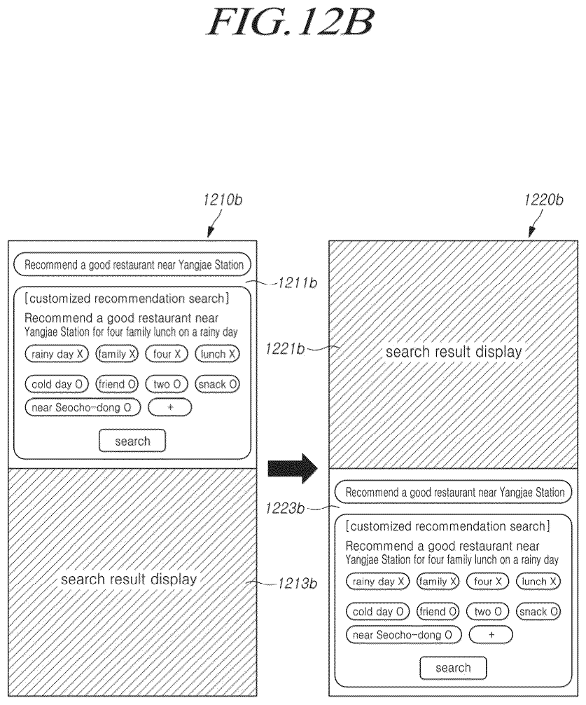

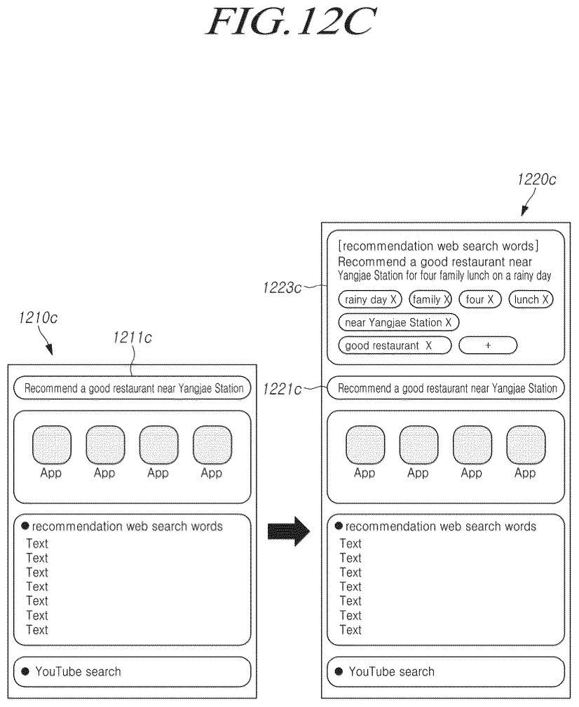

FIGS. 12A to 12C are example views illustrating example prompt editing screen(s) using an expandable display in an electronic device (e.g., the electronic device 101 of FIG. 1 or the electronic device 200 of FIG. 2) (hereinafter, referred to as an ‘electronic device 200’) according to one or more embodiment(s). The prompt editing screen may be a user interface screen to provide editing of the prompt (e.g., the prompt 330 of FIG. 3).

Referring to FIG. 12A, an electronic device 200 of a flexible display (e.g., foldable or slidable) type which may expand the display area of the display as it stretches in a traverse (or horizontal) direction may display a prompt editing screen on a default display area (e.g., the left display area) 1210a irrelevant to whether it expands. The electronic device 200 may display a search result output screen in an expanded display area (e.g., the right display area) 1220a that may be activated in a state in which the flexible display is expanded (e.g., unfolded state).

Referring to FIG. 12B, a flip-able electronic device 200 which is an example of a flexible display in which the display area of the display may expand as it stretches in an axial (or vertical) direction, the displayed format and/or layout may be changed according to the flipped/un-flipped (e.g., unexpanded/expanded) or foldable state. This may take into account a change in the layout and/or format of the display according to the flipped/un-flipped or foldable state.

In the expanded state (e.g., the un-flipped state), the prompt editing screen may be displayed in a first display area (e.g., an upper display area) 1211b. The flip-able electronic device 200 may display the search result output screen in the second display area (e.g., a lower display area) 1213b in the expanded state (e.g., the un-flipped state) of a first expanded display area 1210b.

The flip-able electronic device 200 may switch screen layouts by interaction with the user. According to an example, the flip-able electronic device 200 may move and display the prompt editing screen, which is displayed in the first display area (e.g., the upper display area) 1211b in the expanded state (e.g., the un-flipped state), in the second display area (e.g., the lower display area) 1223b. The flip-able electronic device 200 may move and display the search result output screen, which is displayed in the second display area (e.g., the lower display area) 1213b in the expanded state (e.g., the un-flipped state), in the first display area (e.g., the upper display area) 1221b, of a second expanded display area 1220b.

Referring to FIG. 12C, a rollable electronic device 200 which may expand the display area of the display as it slides in the axial (or vertical) direction may display a first prompt editing screen 1211c including some items (e.g., a search word input bar) for editing the prompt in the first display area (e.g., the default display area) 1210c before expansion. The rollable electronic device 200 may display a second prompt editing screen 1221c and 1223c including all of the items (e.g., search word input bard, prompt, application search word, and recommendation search word) for prompt editing in the second display area 1220c after expansion.

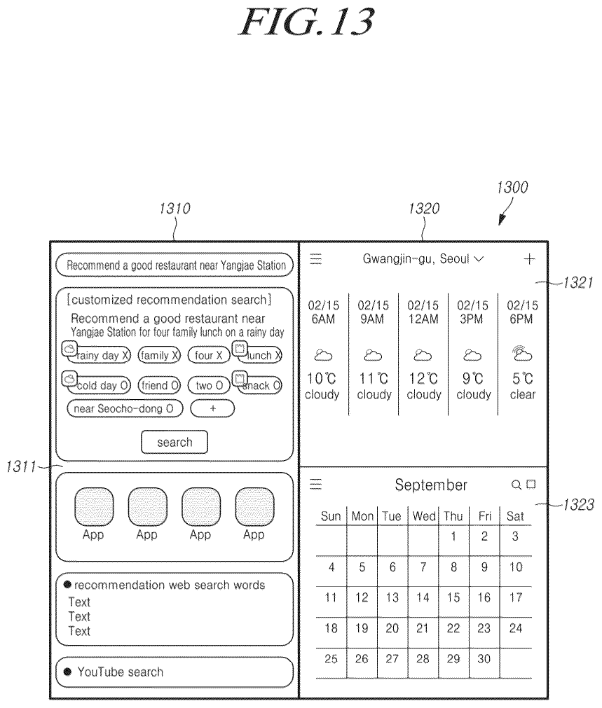

FIG. 13 is a view illustrating an example prompt editing screen in an electronic device (e.g., the electronic device 101 of FIG. 1 or the electronic device 200 of FIG. 2) (hereinafter, referred to as an ‘electronic device 200’) according to one or more embodiment(s).

Referring to FIG. 13, the electronic device 200 may include a display having a size enough to divide and use the display area like an expandable display or a tablet. In this case, the display may provide the display area 1300 in a different layout depending on whether it expands, or screen division. For example, the foldable electronic device 200 that may expand the display area of the display as it stretches in the transverse (or horizontal) direction may provide a first display area 1310 in the unexpanded state (e.g., folded state). For example, information (e.g., user query, prompt, application search word, or recommendation search word) for prompt editing and identification information about applications providing application data analyzed to obtain corresponding information may also be displayed in the first display area 1310.

For example, the foldable electronic device 200 may provide a first display area 1310 and a second display area 1320 in the expanded state (e.g., unfolded state). For example, the electronic device 200 may output a prompt editing screen 1311 through the expandable display. The prompt editing screen 1311 may be a user interface screen to provide editing of the prompt (e.g., the prompt 330 of FIG. 3). The example prompt editing screen 1311 has been sufficiently described above, and thus, a layout in which the detailed items of the prompt editing screen 1311 is to be displayed on the expanded display is described below.

According to an example, the electronic device 200 may output a first screen 1311 that may be selected to remove or add search words (e.g., application search words and/or recommendation search words) for reconfiguring the prompt (e.g., the prompt 330 of FIG. 3) in the first display area (e.g., the left display area) 1310 included in the expanded display area 1300.

According to an example, the electronic device 200 may output at least one second screen 1321 and 1323 where an application (e.g., weather application and/or schedule management application) related to search words (e.g., application search words and/or recommendation search words) for reconfiguring the prompt 330 may be used, in the other second display area (e.g., the right display area) 1320 included in the expanded display area 1300.

According to an example, the electronic device 200 may output the second screen 1321 and 1323 which is the execution screen of the application (e.g., weather application and/or schedule management application) in the expanded display area (e.g., the right display area) 1320 in response to the display switching from the unexpanded state (e.g., folded state) to the expanded state (e.g., unfolded state). The application whose execution screen is output may be related to, e.g., search words (e.g., application search words and/or recommendation search words) for reconfiguring the prompt 330. The first screen 1311 may continue to be output in the default display area (e.g., the left display area 1310) capable of outputting the screen regardless of expansion.

According to an example, the electronic device 200 may no longer output the second screen 1321 and 1323 which is displayed in the expanded display area (e.g., the right display area) 1320 in response to the display shifting from the expanded state (e.g., unfolded state) to the unexpanded state (e.g., folded state). However, the first screen 1311 may continue to be output in the default display area (e.g., the left display area 1310) capable of screen output regardless of expansion.

According to an example, when the electronic device 200 has a display size enough to dispose the first display area 1310 and the second display area 1320, an implementation, according to the screen layout proposed may be possible regardless of whether the display expands.

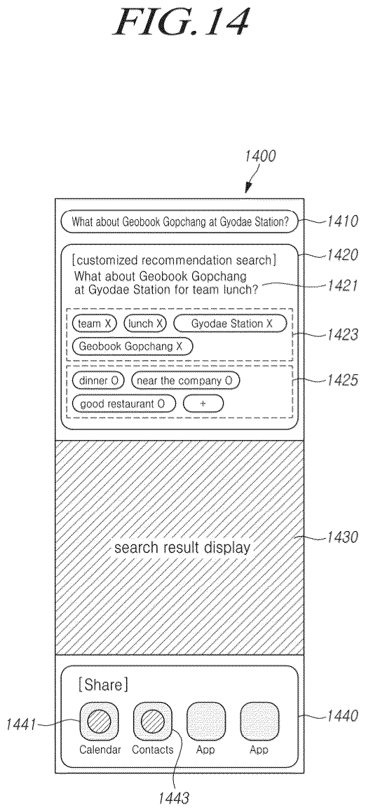

FIG. 14 is a view illustrating an example user interface for supporting utilization of a customized search result in an electronic device (e.g., the electronic device 101 of FIG. 1 or the electronic device 200 of FIG. 2) (hereinafter, referred to as an ‘electronic device 200’) according to one or more embodiment(s).

Referring to FIG. 14, the electronic device 200 may display a search result generated by an AI model (e.g., the generative AI model 430 of FIG. 4) using a customized search prompt generated based on a customized recommendation search as an input in a search result display area 1430 allocated as a portion of the display area 1400 of the display. The customized search prompt corresponds to a prompt obtained by reprocessing the initial prompt generated in response to the user query by a search editing method proposed in the disclosure.

According to an example, the electronic device 200 may display one or more identifiers (e.g., icons) 1441 and 1443 for using the search result for a different purpose in a partial area 1440 allocated to the display area 1400. The one or more identifiers 1441 and 1443 may include, e.g., an identifier 1441 capable of using a specific application (e.g., contacts) providing a function for sharing the search result with colleagues. The one or more identifiers 1441 and 1443 may include, e.g., an identifier 1443 capable of using a specific application (e.g., calendar) providing a function for storing the search result. In this case, the user may conveniently use the search result for other purposes using a predetermined application. The one or more identifiers may also include an identifier for representing information about another device (e.g., my account device) communicatively connected.

According to an example, the electronic device 200 may comprise a display 240. The electronic device 200 may comprise a memory 220 including one or more storage media storing instructions. The electronic device 200 may include at least one processor 210 including a processing circuit. The instructions may, when executed individually and/or collectively by the at least one processor 210, enable (e.g., cause) the electronic device 200 to perform at least one operation. The at least one operation may include obtaining a user query (operation 611). The at least one operation may include accessing at least one application associated with the user query to obtain personal use data. The at least one operation may include obtaining at least one search word associated with the user query from the obtained personal use data (operation 615). The at least one operation may include generating at least one command by tuning the user query based on the obtained at least one search word (operation 617). The at least one operation may include displaying a user interface screen where the user query, the generated at least one command, and the obtained at least one search word are arranged according a specific layout.

According to an example, the at least one operation may include analyzing personal use data and/or log data allowed to be accessed in response to the user query.

According to an example, the instructions may, when executed individually or collectively by the at least one processor 210, enable the electronic device 200 to include, in the user interface screen, result data (e.g., user query data) of processing the user query in a specific AI model (e.g., LLM).

According to an example, the instructions may, when executed individually or collectively by the at least one processor 210, enable the electronic device 200 to analyze the user query.

According to an example, the instructions may, when executed individually or collectively by the at least one processor 210, enable the electronic device 200 to determine the at least one application among applications installed based on a result of analyzing the user query.

According to an example, the instructions may, when executed individually or collectively by the at least one processor 210, enable the electronic device 200 to access the at least one application to obtain the personal use data based on a semantic distance from the user query.

According to an example, the instructions may, when executed individually or collectively by the at least one processor 210, enable the electronic device 200 to, if a plurality of applications are determined (e.g., based on a plurality of applications being determined or identified) based on a result of analyzing the user query, access a corresponding application considering priority of the plurality of applications to sequentially access the plurality of applications.

According to an example, the instructions may, when executed individually or collectively by the at least one processor 210, enable the electronic device 200 to determine a second application by analyzing first personal use data obtained by accessing a first application included in the at least one application.

According to an example, the instructions may, when executed individually or collectively by the at least one processor 210, enable the electronic device 200 to obtain second personal use data by accessing the determined second application.

According to an example, the instructions may, when executed individually or collectively by the at least one processor 210, enable the electronic device 200 to include, in the user interface screen, result data (e.g., prompt data) of processing the generated at least one command in the specific AI model.

According to an example, the obtained at least one search word may include at least one application search word applied to the generated at least one command or at least one recommendation search word not applied to the generated at least one command.

According to an example, the instructions may, when executed individually or collectively by the at least one processor 210, enable the electronic device 200 to determine at least one additional search word among the one or more search words.

According to an example, the instructions may, when executed individually or collectively by the at least one processor 210, enable the electronic device 200 to tune the generated at least one command based on the determined at least one additional search word.

According to an example, the instructions may, when executed individually or collectively by the at least one processor 210, enable the electronic device 200 to determine at least one removal search word among the one or more application search words.

According to an example, the instructions may, when executed individually or collectively by the at least one processor 210, enable the electronic device 200 to tune the generated at least one command based on the determined at least one removal search word.

According to an example, the obtained personal use data may be data allowed to be used by a user for the at least one application.

According to an example, the instructions may, when executed individually or collectively by the at least one processor 210, enable the electronic device 200 to, if a plurality of prompts are generated, output a user interface for selecting at least one of the plurality of prompts through the display.

According to an example, the instructions may, when executed individually or collectively by the at least one processor 210, enable the electronic device 200 to output information about the at least one application through the display.

According to an example, the instructions may, when executed individually or collectively by the at least one processor 210, enable the electronic device 200 to determine a number of applications to be accessed to obtain the personal use data considering priorities assigned to applications based on the user query.

According to an example, the instructions may, when executed individually or collectively by the at least one processor 210, enable the electronic device 200 to, if data used to obtain the at least one search word is provided from another device, output information about the other device through the display.

According to an example, there may be provided a storage medium storing computer-readable instructions. The instructions may, when executed by at least some of at least one processor of an electronic device, enable the electronic device to perform at least one operation. The at least one operation may include obtaining a user query (operation 611). The at least one operation may include accessing at least one application associated with the user query to obtain personal use data. The at least one operation may include obtaining at least one search word associated with the user query from the obtained personal use data (operation 615).

The at least one operation may include generating at least one command by tuning the user query based on the obtained at least one search word (operation 617). The at least one operation may include displaying a user interface screen where the user query, the generated at least one command, and the obtained at least one search word are arranged according a specific layout.

According to an example, displaying the user interface screen may include including, in the user interface screen, result data of processing the user query in the specific AI model.

According to an example, obtaining the personal use data may include analyzing the user query.

According to an example, obtaining the personal use data may include applications installed based on a result of analyzing the user query.

According to an example, obtaining the personal use data may include accessing the at least one application to obtain the personal use data based on a semantic distance from the user query.

According to an example, obtaining the personal use data may include, if a plurality of applications are determined based on a result of analyzing the user query, accessing a corresponding application considering priority of the plurality of applications to sequentially access the plurality of applications.

According to an example, obtaining the personal use data may include determining a second application by analyzing first personal use data obtained by accessing a first application included in the at least one application.

According to an example, obtaining the personal use data may include obtaining second personal use data by accessing the determined second application.

According to an example, displaying the user interface screen may include including, in the user interface screen, result data of processing the generated at least one command in a specific AI model (e.g., LLM).

According to an example, the obtained at least one search word may include at least one application search word applied to the generated at least one command or at least one recommendation search word not applied to the generated at least one command.

According to an example, the at least one operation may include determining at least one additional search word among the one or more recommendation search words.

According to an example, the at least one operation may include tuning the generated at least one command based on the determined at least one additional search word.

According to an example, generating the at least one command may include determining at least one removal search word among the one or more application search words.

According to an example, generating the at least one command may include tuning the generated at least one command based on the determined at least one removal search word.

According to an example, the obtained personal use data may be data allowed to be used by a user for the at least one application.

According to an example, displaying the user interface screen may include, if a plurality of prompts are generated, outputting a user interface for selecting at least one of the plurality of prompts through the display 240.

According to an example, displaying the user interface screen may include outputting information about the at least one application through the display 240.

According to an example, the at least one operation may include determining a number of applications to be accessed to obtain the personal use data considering priorities assigned to applications based on the user query.

According to an example, displaying the user interface screen may include, if data used to obtain the at least one search word is provided from another device, outputting information about the other device through the display.

According to an example, a method for operating an electronic device 200 may comprise obtaining a user query (operation 611). The operation method may comprise accessing at least one application associated with the user query to obtain personal use data. The operation method may comprise obtaining at least one search word associated with the user query from the obtained personal use data (operation 615). The operation method may comprise generating at least one command by tuning the user query based on the obtained at least one search word (operation 617). The operation method may comprise displaying a user interface screen where the user query, the generated at least one command, and the obtained at least one search word are arranged according a specific layout.

According to an example, in the operation method, displaying the user interface screen may include including, in the user interface screen, result data of processing the user query in the specific AI model.

According to an example, obtaining the personal use data may include analyzing the user query.

According to an example, obtaining the personal use data may include applications installed based on a result of analyzing the user query.

According to an example, obtaining the personal use data may include accessing the at least one application to obtain the personal use data based on a semantic distance from the user query.

According to an example, obtaining the personal use data may include, if a plurality of applications are determined based on a result of analyzing the user query, accessing a corresponding application considering priority of the plurality of applications to sequentially access the plurality of applications.

According to an example, obtaining the personal use data may include determining a second application by analyzing first personal use data obtained by accessing a first application included in the at least one application.

According to an example, obtaining the personal use data may include obtaining second personal use data by accessing the determined second application.

According to an example, displaying the user interface screen may include including, in the user interface screen, result data of processing the generated at least one command in a specific AI model (e.g., LLM).

According to an example, the obtained at least one search word may include at least one application search word applied to the generated at least one command or at least one recommendation search word not applied to the generated at least one command.

According to an example, the operation method may comprise determining at least one additional search word among the one or more recommendation search words.

According to an example, the operation method may comprise tuning the generated at least one command based on the determined at least one additional search word.

According to an example, generating the at least one command may include determining at least one removal search word among the one or more application search words.

According to an example, generating the at least one command may include tuning the generated at least one command based on the determined at least one removal search word.

According to an example, the obtained personal use data may be data allowed to be used by a user for the at least one application.

According to an example, displaying the user interface screen may include, if a plurality of prompts are generated, outputting a user interface for selecting at least one of the plurality of prompts through the display 240.

According to an example, displaying the user interface screen may include outputting information about the at least one application through the display 240.

According to an example, the operation method may comprise determining a number of applications to be accessed to obtain the personal use data considering priorities assigned to applications based on the user query.

According to an example, displaying the user interface screen may include, if data used to obtain the at least one search word is provided from another device, outputting information about the other device through the display.

The electronic device according to one or more embodiment(s) may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in the form of an application-specific integrated circuit (ASIC).

Various embodiments as set forth herein may be implemented as software (e.g., the program) including one or more instructions that are stored in a storage medium (e.g., the memory 220) that is readable by a machine (e.g., the electronic device 200). For example, a processor (e.g., the processor 210) of the machine (e.g., the electronic device 200) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one or more embodiment(s), each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a display;
a memory including one or more storage media storing instructions; and
at least one processor including a processing circuit,
wherein the instructions, when executed by the at least one processor individually or collectively, cause the electronic device to:
obtain a user query;
access at least one application associated with the user query to obtain personal use data;
obtain at least one search word associated with the user query from the obtained personal use data;
generate at least one command by tuning the user query based on the obtained at least one search word; and
display, via the display, a user interface screen in which the user query, the generated at least one command, and the obtained at least one search word are arranged according a layout.

2. The electronic device of claim 1, wherein the instructions, when executed by the at least one processor individually or collectively, cause the electronic device to display, in the user interface screen, user query data from processing the user query in an artificial intelligence (AI) model or prompt data from processing the generated at least one command.

3. The electronic device of claim 1, wherein the instructions, when executed by the at least one processor individually or collectively, cause the electronic device to:
analyze the user query;
identify at least one application among applications installed based on a result of analyzing the user query; and
access the identified at least one application to obtain the personal use data based on a semantic distance from the user query, and
wherein the obtained personal use data is data allowed to be used by a user for the identified at least one application.

4. The electronic device of claim 3, wherein the instructions, when executed by the at least one processor individually or collectively, cause the electronic device to, based on a plurality of applications being identified based on the result of analyzing the user query, access a corresponding application based on a priority of the plurality of applications to sequentially access the plurality of applications.

5. The electronic device of claim 1, wherein the instructions, when executed by the at least one processor individually or collectively, cause the electronic device to:
identify a second application by analyzing first personal use data obtained by accessing a first application included in the at least one application; and
obtain second personal use data by accessing the identified second application.

6. The electronic device of claim 1, wherein the instructions, when executed by the at least one processor individually or collectively, cause the electronic device to:
based on a plurality of prompts being generated, output a user interface for selecting at least one of the plurality of prompts through the display; and
output information about the at least one application through the display.

7. The electronic device of claim 1, wherein the instructions, when executed by the at least one processor individually or collectively, cause the electronic device to identify a number of applications to be accessed to obtain the personal use data considering priorities assigned to applications based on the user query.

8. The electronic device of claim 1, wherein the instructions, when executed by the at least one processor individually or collectively, cause the electronic device to, based on data used to obtain the at least one search word being provided from another device, output information about the other device through the display, and
wherein the obtained at least one search word comprises at least one application search word applied to the generated at least one command or at least one recommendation search word not applied to the generated at least one command.

9. The electronic device of claim 8, wherein the instructions, when executed by the at least one processor individually or collectively, cause the electronic device to:
identify at least one additional search word among the at least one recommendation search word;
tune the generated at least one command based on the identified at least one additional search word;
identify at least one removal search word among the at least one application search word; and
tune the generated at least one command based on the identified at least one removal search word.

10. A non-transitory computer-readable recording medium storing at least one computer-readable instruction, wherein the at least one computer-readable instruction, when executed by at least one processor of an electronic device, causes the electronic device to perform operations comprising:
obtaining a user query;
accessing at least one application associated with the user query to obtain personal use data;
obtaining at least one search word associated with the user query from the obtained personal use data;
generating at least one command by tuning the user query based on the obtained at least one search word; and
displaying a user interface screen in which the user query, the generated at least one command, and the obtained at least one search word are arranged according a layout.

11. The non-transitory computer-readable recording medium of claim 10, wherein the displaying the user interface screen comprises displaying, in the user interface screen, user query data from processing the user query in an artificial intelligence (AI) model or prompt data from processing the generated at least one command.

12. The non-transitory computer-readable recording medium of claim 10, wherein the obtaining the personal use data comprises:
analyzing the user query;
identifying at least one application among applications installed based on a result of analyzing the user query; and
accessing the at least one application to obtain the personal use data based on a semantic distance from the user query,
wherein the obtained personal use data is data allowed to be used by a user for the at least one application.

13. The non-transitory computer-readable recording medium of claim 12, wherein the obtaining the personal use data comprises, based on a plurality of applications being identified based on the result of analyzing the user query, accessing a corresponding application based on a priority of the plurality of applications to sequentially access the plurality of applications.

14. The non-transitory computer-readable recording medium of claim 10, wherein the obtaining the personal use data comprises:
identifying a second application by analyzing first personal use data obtained by accessing a first application included in the at least one application; and
obtaining second personal use data by accessing the identified second application.

15. The non-transitory computer-readable recording medium of claim 10, wherein the displaying the user interface screen comprises, based on a plurality of prompts being generated, outputting a user interface for selecting at least one of the plurality of prompts through a display.

16. The non-transitory computer-readable recording medium of claim 10, wherein the displaying the user interface screen comprises:
outputting information about the at least one application through a display.

17. The non-transitory computer-readable recording medium of claim 10, wherein the operations further comprise identifying a number of applications to be accessed to obtain the personal use data considering priorities assigned to applications based on the user query.

18. The non-transitory computer-readable recording medium of claim 10, wherein the displaying the user interface screen comprises, based on data used to obtain the at least one search word being provided from another device, outputting information about the other device through a display, and
wherein the obtained at least one search word comprises at least one application search word applied to the generated at least one command or at least one recommendation search word not applied to the generated at least one command.

19. The non-transitory computer-readable recording medium of claim 18, wherein the generating at least one command comprises:
identifying at least one additional search word among the at least one recommendation search word;
tuning the generated at least one command based on the identified at least one additional search word;
identifying at least one removal search word among the at least one application search word; and
tuning the generated at least one command based on the identified at least one removal search word.

20. A method for operating an electronic device, the method comprising:
obtaining a user query;
accessing at least one application associated with the user query to obtain personal use data;
obtaining at least one search word associated with the user query from the obtained personal use data;
generating at least one command by tuning the user query based on the obtained at least one search word; and
displaying a user interface screen in which the user query, the generated at least one command, and the obtained at least one search word are arranged according a layout.
